(19) United States
(12) Patent Application Publication
(10) Pub. No.: US 2024/0183112 A1
(43) Pub. Date: Jun. 6, 2024

(54) METHOD FOR MANUFACTURING CELLULOSE PRODUCTS AND A PRODUCT FORMING UNIT FOR MANUFACTURING CELLULOSE PRODUCTS

(71) Applicant: PulPac AB, Västra Frölunda (SE)

(72) Inventors: Ove Larsson, Västra Frölunda (SE); Olle Högblom, Göteborg (SE); Martin Ljungberg, Göteborg (SE)

(21) Appl. No.: 18/285,461

(22) PCT Filed: Apr. 15, 2021
(86) PCT No.: PCT/EP2021/059811

§ 371 Date: Oct. 3, 2023

(51) Int. Cl. D21J 5/00; B65H 23/188

(52) U.S. Cl. CPC D21J 5/00; B65H 23/1882; B65H 2301/543; B65H 2701/177; B65H 2801/84

(57) ABSTRACT

A method for manufacturing non-flat cellulose products from an air-formed cellulose blank structure in a product forming unit. The product forming unit includes a buffering module and a pressing module including one or more forming molds. The method includes providing the cellulose blank structure and feeding the cellulose blank structure to the buffering module; buffering the cellulose blank structure in the buffering module, and feeding the cellulose blank structure from the buffering module to the pressing module; forming cellulose products from the cellulose blank structure in the one or more forming molds by heating the cellulose blank structure to a forming temperature, and pressing the cellulose blank structure with a forming pressure. The cellulose blank structure is continuously fed to the buffering module in a first feeding direction, and intermittently fed from the buffering module in a second feeding direction, wherein the second feeding direction differs from the first feeding direction.

### TECHNICAL FIELD

The present disclosure relates to a method for manufacturing cellulose products from an air-formed cellulose blank structure in a product forming unit. The product forming unit comprises a buffering module and a pressing module, where the pressing module comprises one or more forming molds for forming the cellulose products from the cellulose blank structure. The cellulose products are formed from the cellulose blank structure in the one or more forming molds by heating the cellulose blank structure to a forming temperature, and pressing the cellulose blank structure with a forming pressure. The disclosure further relates to a product forming unit for manufacturing cellulose products from an air-formed cellulose blank structure.

### BACKGROUND

Cellulose fibers are often used as raw material for producing or manufacturing products. Products formed of cellulose fibers can be used in many different situations where there is a need for having sustainable products. A wide range of products can be produced from cellulose fibers and a few examples are disposable plates and cups, cutlery, lids, bottle caps, coffee pods, and packaging materials.

Forming molds are commonly used when manufacturing cellulose products from cellulose fiber raw materials, and traditionally the cellulose products are wet-formed. A material commonly used for wet-forming cellulose fiber products is wet molded pulp. Wet molded pulp has the advantage of being considered as a sustainable packaging material, since it is produced from biomaterials and can be recycled after use. Consequently, wet molded pulp has been quickly increasing in popularity for different applications. Wet molded pulp articles are generally formed by immersing a suction forming mold into a liquid or semi liquid pulp suspension or slurry comprising cellulose fibers, and when suction is applied, a body of pulp is formed with the shape of the desired product by fiber deposition onto the forming mold. With all wet-forming techniques, there is a need for drying of the wet molded product, where the drying is a very time and energy consuming part of the production. The demands on aesthetical, chemical and mechanical properties of cellulose products are increasing, and due to the properties of wet-formed cellulose products, the mechanical strength, flexibility, freedom in material thickness, and chemical properties are limited. It is also difficult in wet-forming processes to control the mechanical properties of the products with high precision.

One development in the field of producing cellulose products is the forming of cellulose fibers in a dry-forming process, without using wet-forming. Instead of forming the cellulose products from a liquid or semi liquid pulp suspension or slurry, an air-formed cellulose blank structure is used. The air-formed cellulose blank structure is inserted into forming molds and during the forming of the cellulose products the cellulose blank structure is subjected to a high forming pressure and a high forming temperature in the forming molds.

Product forming units are used when dry-forming the cellulose products, and the product forming units commonly use a pressing module comprising the forming molds. Other modules and components are arranged in connection to the pressing module in the product forming unit, such as for example feeding modules, buffering modules, and blank dry forming modules. The product forming units are normally using high capacity pressing modules, such as vertical hydraulic pressing units commonly used for forming other materials, such as steel plates, due to the need for establishing high product forming pressure in the forming molds. Blank forming modules are commonly sourced from the hygiene industry, such as forming modules from diaper production units. The product forming units used are due to the type of standard modules used, and high number of modules and components involved occupying large spaces in manufacturing facilities.

One drawback of using standard modules developed for other purposes is the required engineering work to integrate the different modules, from different industries, into a product forming unit for manufacturing cellulose products from a dry-formed cellulose blank structure. Such projects can typically require six to twelve months with several person-years behind each product forming unit, normally ending up in custom-made industrial lines with less value for reproduction or scale-up. The integration of different modules into a product forming unit from separately purchased modules constitutes a hurdle to go over to dry-forming for many converters. A complete, fully integrated, standardized production forming unit ready to purchase, ship, install and run, is therefore highly demanded.

There is thus a need for an improved method for manufacturing cellulose products from an air-formed cellulose blank structure in a product forming unit, and a product forming unit for manufacturing cellulose products from an air-formed cellulose blank structure cellulose blank structure, with a more compact layout and construction.

### SUMMARY

An object of the present disclosure is to provide a method for manufacturing non-flat cellulose products from an air-formed cellulose blank structure in a product forming unit, and a product forming unit for manufacturing non-flat cellulose products from an air-formed cellulose blank structure, where the previously mentioned problems are avoided. This object is at least partly achieved by the features of the independent claims. The dependent claims contain further developments of the method for manufacturing non-flat cellulose products from an air-formed cellulose blank structure in a product forming unit, and the product forming unit for manufacturing non-flat cellulose products from an air-formed cellulose blank structure.

The disclosure concerns a method for manufacturing non-flat cellulose products from an air-formed cellulose blank structure in a product forming unit. The product forming unit comprises a buffering module and a pressing module comprising one or more forming molds. The method comprises the steps: providing the cellulose blank structure and feeding the cellulose blank structure to the buffering module; buffering the cellulose blank structure in the buffering module, and feeding the cellulose blank structure from the buffering module to the pressing module; forming cellulose products from the cellulose blank structure in the one or more forming molds by heating the cellulose blank structure to a forming temperature, and pressing the cellulose blank structure with a forming pressure. The cellulose blank structure is continuously fed to the buffering module in a first feeding direction, and intermittently fed from the buffering module in a second feeding direction, wherein the second feeding direction differs from the first feeding direction.

Advantages with these features are that the differing feeding directions enable the optimized modules to be integrated into one single unit or machinery possible to ship in a freight container, place on a converter's plant floor, connect and start production in a few months with no or very little module engineering skill required from the converter. Further advantages are that the differing feeding directions enable a more compact layout and construction of the product forming unit. With this configuration, the modules can be positioned in relation to each other in a non-conventional manner for an efficient and compact layout. Moreover, the integrated module design enables the weight of the production forming unit to be several times less than today's units with aligned discrete separately purchased modules into a custom-made industrial line. The weight of machinery commonly relates to the purchase price, why this solution also lowers the investment costs with several times for the converter. The lower investment costs enable a faster conversion to products made of cellulose raw materials instead of plastic materials.

According to an aspect of the disclosure, the first feeding direction is opposite to, or essentially opposite to, the second feeding direction. This enables an efficient feeding of the cellulose blank structure, where the cellulose blank structure is redirected from the first feeding direction to the second feeding direction, where the directions are opposite to each other, or essentially opposite to each other.

According to another aspect of the disclosure, the first feeding direction is an upwards direction and the second feeding direction is a downwards direction. This enables a smart and efficient layout of the product forming unit, where the unit can be built in a vertical direction for a compact layout.

According to a further aspect of the disclosure, the cellulose blank structure is intermittently fed from the buffering module to the pressing module. The intermittent feeding is securing an efficient transportation of the cellulose blank structure into the pressing module, which is operating intermittently.

According to an aspect of the disclosure, the buffering module is configured for alternatingly operating in a buffering mode and a feeding mode. The method further comprises the steps: feeding the cellulose blank structure to the buffering module in the buffering mode and the feeding mode with a continuous input speed; and feeding the cellulose blank structure from the buffering module in the buffering mode with an output speed lower than the output speed of the cellulose blank structure from the buffering module in the feeding mode. The continuous input speed is securing a stable transport of the cellulose blank structure into the buffering module. The lower output speed in the buffering mode is allowing a buffer of the cellulose blank structure to be built in the buffering module.

According to another aspect of the disclosure, the output speed in the buffering mode is zero, or the output speed in the buffering mode is essentially zero. These speed options are securing an efficient intermittent feeding of the cellulose blank structure to the pressing module.

According to a further aspect of the disclosure, the buffering module comprises an inlet portion, an outlet portion, and a buffering portion between the inlet portion and the outlet portion. The cellulose blank structure has a buffering extension in the buffering portion between the inlet portion and the outlet portion. The method further comprises the steps: gradually increasing the buffering extension of the cellulose blank structure in the buffering portion during the buffering mode, and gradually decreasing the buffering extension of the cellulose blank structure in the buffering portion during the feeding mode. This operation of the buffering module is enabling a smooth buffering of the cellulose blank structure as well as a smooth release of the cellulose blank structure from the buffering module.

According to an aspect of the disclosure, the buffering portion comprises a guide member, where the guide member comprises a first arm section and a second arm section configured for intermittently varying the buffering extension in the buffering mode and the feeding mode. The method comprises the steps: varying an angular relationship between the first arm section and the second arm section in the buffering mode and the feeding mode for varying the buffering extension. The varying angular relationship is ensuring an efficient and compact layout of the buffering module, and the arm sections are used for changing the buffering extension in the different modes.

According to another aspect of the disclosure, the method further comprises the steps: continuously feeding the cellulose blank structure to the inlet portion and intermittently feeding the cellulose blank structure from the outlet portion through activation of the guide member. During activation of the guide member in the buffering mode a buffer of the cellulose blank structure is built in the buffering portion. During activation of the guide member in the feeding mode a buffer of the cellulose blank structure is released from the buffering portion.

According to a further aspect of the disclosure, the product forming unit comprises a blank dry-forming module configured for providing the cellulose blank structure. The method comprises the steps: providing a cellulose raw material and feeding the cellulose raw material to the blank dry-forming module; dry-forming the cellulose blank structure from the cellulose raw material in the blank dry-forming module; and feeding the cellulose blank structure from the blank dry-forming module to the buffering module. The blank dry-forming module is enabling a forming of the cellulose blank structure in close connection to the pressing module, without the need for pre-fabricating the cellulose blank structure. Due to the modular configuration of the product forming unit, a compact layout can be achieved. Further, the operation of the product forming unit is efficient with the cellulose raw material used as input material for in-line production of the cellulose blank structure.

According to an aspect of the disclosure, the blank dry-forming module comprises a mill, a forming chamber, and a forming wire arranged in connection to the forming chamber. The method further comprises the steps: separating fibers from the cellulose raw material in the mill and distributing the separated fibers into the forming chamber onto the forming wire for forming the cellulose blank structure.

According to another aspect of the disclosure, the forming wire comprises a forming section arranged in connection to a forming chamber opening of the forming chamber. The method further comprises the step: forming the cellulose blank structure onto the forming section.

According to a further aspect of the disclosure, the forming section is extending in an upwards blank forming direction. The method further comprises the steps: forming the cellulose blank structure onto the forming section, and transporting the formed cellulose blank structure from the forming section in the upwards blank forming direction towards the buffering module. The non-conventional upwards extension of the forming section is enabling a compact layout of the product forming unit, since the cellulose blank structure can be formed in an upwards direction for direct transportation to the buffering module.

According to an aspect of the disclosure, the product forming unit comprises a blank recycling module. The method further comprises the steps: feeding residual parts of the cellulose blank structure from the pressing module to the blank dry-forming module. The feeding of the residual part is securing that non-used parts of the cellulose blank structure can be re-used.

According to another aspect of the disclosure, the product forming unit comprises a barrier application module arranged upstream the buffering module. The method further comprises the step: applying a barrier composition onto the cellulose blank structure in the barrier application module. The barrier composition is used for altering the hydrophobic properties of the cellulose products.

According to a further aspect of the disclosure, the method further comprises the steps: forming the cellulose products from the cellulose blank structure in the one or more forming molds by heating the cellulose blank structure to a forming temperature in the range of 100-300° C., and pressing the cellulose blank structure with a forming pressure in the range of 1-100 MPa, preferably 4-20 MPa. These parameters are providing an efficient forming of the cellulose products, where strong hydrogen bonds are formed.

According to an aspect of the disclosure, the pressing module is a cellulose product toggle pressing module for forming the non-flat cellulose products from the cellulose blank structure. The method further comprises the steps: providing the cellulose product toggle pressing module having a toggle press and the one or more forming molds, wherein the toggle press includes a pressing member movably arranged in a pressing direction, a toggle-mechanism connected to the pressing member, a pressing actuator arrangement connected to the toggle-mechanism, and an electronic control system operatively connected to the pressing actuator arrangement, and wherein the one or more forming molds each includes a moveable first mold part attached to the pressing member and a stationary second mold part; installing the toggle press with the pressing direction of the pressing member arranged primarily in a horizontal direction, specifically with the pressing direction of the pressing member arranged within 20 degrees from the horizontal direction, and more specifically with the pressing direction in parallel with the horizontal direction; feeding the cellulose blank structure into a pressing area defined by the first and second, spaced apart, mold parts; controlling operation of the pressing actuator arrangement by means of the electronic control system for driving the pressing member using the toggle-mechanism in the pressing direction and forming the cellulose products from the cellulose blank structure by pressing each first forming mold part against the stationary second forming mold part. The primarily horizontal orientation of the toggle press enables a low build height of the cellulose product forming unit, and a non-straight material flow of the cellulose blank structure from the blank dry-forming module to the pressing module. Since a continuous web of cellulose fiber material is typically supplied to the pressing module at about right angles to the pressing direction of the pressing module, a primarily horizontal orientation of the toggle press is typically associated with a primarily vertically arranged supply flow of the continuous cellulose blank structure. Consequently, it is clear that a primarily horizontally arranged pressing module is highly beneficial when developing a compact cellulose product forming unit for efficient production of the cellulose products with the pressing member arranged primarily in a horizontal direction, specifically with the pressing direction of the pressing member arranged within 20 degrees from the horizontal direction, and more specifically with the pressing direction in parallel with the horizontal direction.

The disclosure further concerns a product forming unit for manufacturing non-flat cellulose products from an air-formed cellulose blank structure. The product forming unit comprises, a buffering module, and a pressing module comprising one or more forming molds. The product forming unit is adapted for feeding the cellulose blank structure to the buffering module, buffering the cellulose blank structure in the buffering module, and feeding the cellulose blank structure from the buffering module to the pressing module. The product forming unit is further adapted for forming the cellulose products from the cellulose blank structure in the one or more forming molds by heating the cellulose blank structure to a forming temperature, and pressing the cellulose blank structure with a forming pressure. The buffering module comprises a blank feeding system configured for continuously feeding the cellulose blank structure to the buffering module in a first feeding direction, and intermittently feeding the cellulose blank structure from the buffering module in a second feeding direction, wherein the second feeding direction differs from the first feeding direction.

Advantages with these features are that the differing feeding directions enable a more compact layout and construction of the product forming unit. With this configuration, the modules can be positioned in relation to each other in a non-conventional manner for an efficient and compact layout.

According to an aspect of the disclosure, the buffering module comprises an inlet portion, an outlet portion, and a buffering portion between the inlet portion and the outlet portion. The cellulose blank structure is arranged with a buffering extension in the buffering portion between the inlet portion and the outlet portion. The buffering portion is configured for gradually increasing the buffering extension of the cellulose blank structure during a buffering mode, and gradually decreasing the buffering extension of the cellulose blank structure during a feeding mode. This configuration of the buffering module is enabling a smooth buffering of the cellulose blank structure as well as a smooth release of the cellulose blank structure from the buffering module.

According to another aspect of the disclosure, the buffering portion comprises a guide member, where the guide member comprises a first arm section and a second arm section configured for intermittently varying the buffering extension in the buffering mode and the feeding mode. The buffering portion is configured for varying an angular relationship between the first arm section and the second arm section in the buffering mode and the feeding mode for varying the buffering extension. The varying angular relationship is ensuring an efficient and compact layout of the buffering module, and the arm sections are used for changing the buffering extension in the different modes.

According to a further aspect of the disclosure, the blank feeding system comprises at least one blank feeding roller arranged in connection to or upstream the inlet portion, and/or in connection to or downstream the outlet portion. The blank feeding roller are used for securing a desired transportation of the cellulose blank structure into the buffering module and away from the buffering module.

According to an aspect of the disclosure, the buffering module comprises a first blank redirecting device arranged upstream the inlet portion and/or a second blank redirecting device arranged downstream the outlet portion. The redirecting devices are used for changing the direction of the cellulose blank structure within the buffering module, which may be needed depending on the design and construction of the buffering module.

According to another aspect of the disclosure, the blank feeding system is configured for continuously feeding the cellulose blank structure to the inlet portion and intermittently feeding the cellulose blank structure from the outlet portion through activation of the guide member. During activation of the guide member in the buffering mode a buffer of the cellulose blank structure is built in the buffering portion. During activation of the guide member in the feeding mode the buffer of the cellulose blank structure is released from the buffering portion.

According to a further aspect of the disclosure, the product forming unit comprises a blank dry-forming module configured for providing the cellulose blank structure. The blank dry-forming module is enabling a forming of the cellulose blank structure in close connection to the pressing module, without the need for pre-fabricating the cellulose blank structure. Due to the modular configuration of the product forming unit, a compact layout can be achieved.

According to an aspect of the disclosure, the blank dry-forming module comprises a mill, a forming chamber, and a forming wire arranged in connection to the forming chamber. The mill is configured for separating fibers from a cellulose raw material. The forming chamber is configured for distributing the separated fibers onto a forming section of the forming wire for forming the cellulose blank structure.

According to another aspect of the disclosure, the forming section is extending in an upwards blank forming direction. The non-conventional upwards extension of the forming section is enabling a compact layout of the product forming unit, since the cellulose blank structure can be formed in an upwards direction for direct transportation to the buffering module.

According to a further aspect of the disclosure, the product forming unit comprises a blank recycling module configured for feeding residual parts of the cellulose blank structure from the pressing module to the blank dry-forming module. The recycling module is securing that the residual parts of the cellulose blank structure can be re-used.

According to an aspect of the disclosure, the product forming unit comprises a barrier application module arranged upstream the buffering module. The barrier application module is configured for applying a barrier composition onto the cellulose blank structure. The barrier application module is efficiently applying the barrier composition onto the cellulose blank structure for altering the hydrophobic properties of the cellulose products.

According to another aspect of the disclosure, the one or more forming molds are configured for forming the cellulose products from the cellulose blank structure by heating the cellulose blank structure to a forming temperature in the range of 100-300° C., and pressing the cellulose blank structure with a forming pressure in the range of 1-100 MPa, preferably 4-20 MPa. These parameters are providing an efficient forming of the cellulose products, where strong hydrogen bonds are formed.

According to a further aspect of the disclosure, the pressing module is a cellulose product toggle pressing module for forming the non-flat cellulose products from the cellulose blank structure. The pressing module comprises: a toggle press including a pressing member movably arranged in a pressing direction, a toggle-mechanism drivingly connected to the pressing member, a pressing actuator arrangement drivingly connected to the toggle-mechanism, and an electronic control system operatively connected to the pressing actuator arrangement, and the one or more forming molds, each including a moveable first forming mold part attached to the pressing member and a stationary second forming mold part. The electronic control system is configured for controlling operation of the pressing actuator arrangement for driving the pressing member using the toggle-mechanism in the pressing direction and forming the non-flat cellulose products from the air-formed cellulose blank structure by pressing the first forming mold part against the stationary second forming mold part. The toggle press is installed with, or arranged for being installed with, the pressing direction of the pressing member arranged primarily in a horizontal direction, specifically with the pressing direction of the pressing member arranged within 20 degrees from the horizontal direction, and more specifically with the pressing direction in parallel with the horizontal direction. The primarily horizontal orientation of the toggle press enables a low build height of the cellulose product forming unit, and a non-straight material flow of the cellulose blank structure from the blank dry-forming module to the pressing module. A non-straight material flow, where the continuous air-formed cellulose blank structure is routed in a first direction, such as for example upwards and subsequently in a second direction, such as for example downwards, generally enables development and manufacturing of a more compact cellulose product forming unit. Since a continuous web of cellulose fiber material is typically supplied to the pressing module at about right angles to the pressing direction of the pressing module, a primarily horizontal orientation of the toggle press is typically associated with a primarily vertically arranged supply flow of the continuous cellulose blank structure. Consequently, it is clear that a primarily horizontally arranged pressing module is highly beneficial when developing a compact cellulose product forming unit having a non-straight material flow of the cellulose blank structure from the blank dry-forming module to the pressing module.

### BRIEF DESCRIPTION OF DRAWINGS

The disclosure will be described in detail in the following, with reference to the attached drawings, in which

FIG. 1a-c show schematically, in a side view and perspective views, a product forming unit according to the disclosure,

FIG. 1d-e show schematically, two example embodiments of routing of a cellulose blank structure within the product forming unit, according to the disclosure,

FIG. 2 shows schematically, in a perspective view, a blank dry-forming module according to the disclosure,

FIG. 3 shows schematically, in a perspective view, a buffering module according to the disclosure,

FIG. 4a-d show schematically, in side views, the buffering module according to the disclosure,

FIG. 5a-e show schematically, in side views, buffering modules according to alternative embodiments of the disclosure,

FIG. 6a-e show schematically, in a perspective view and in side views, a pressing module according to the disclosure, and

FIG. 7a-b show schematically, in side views, pressing modules according to alternative embodiments of the disclosure.

### DETAILED DESCRIPTION OF DRAWINGS

Various aspects of the disclosure will hereinafter be described in conjunction with the appended drawings to illustrate and not to limit the disclosure, wherein like designations denote like elements, and variations of the described aspects are not restricted to the specifically shown embodiments, but are applicable on other variations of the disclosure.

Those skilled in the art will appreciate that the steps, services and functions explained herein may be implemented using individual hardware circuitry, using software functioning in conjunction with a programmed microprocessor or general purpose computer, using one or more APplication Specific Integrated Circuits (ASICs) and/or using one or more Digital Signal Processors (DSPs). It will also be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

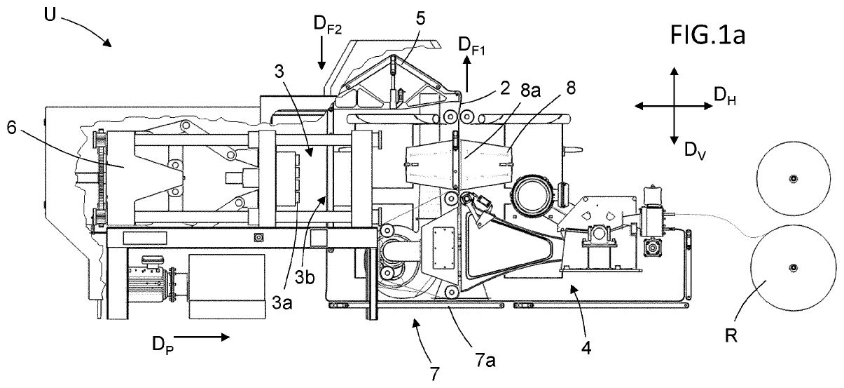

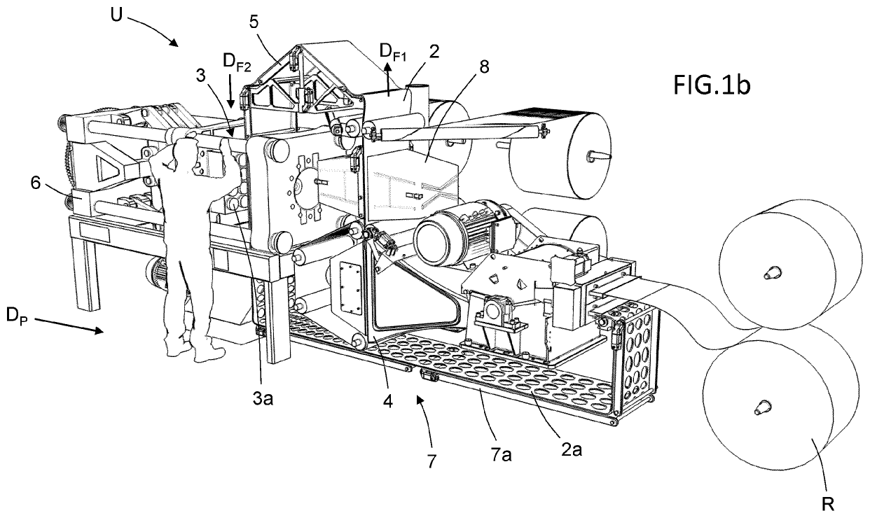

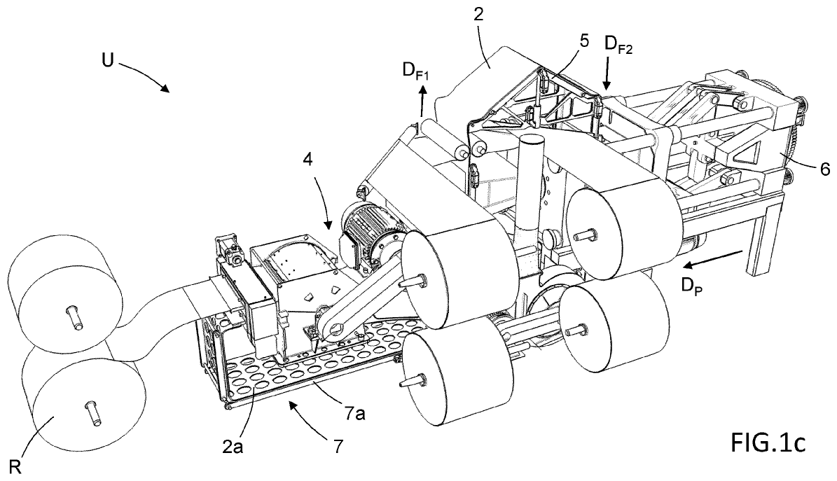

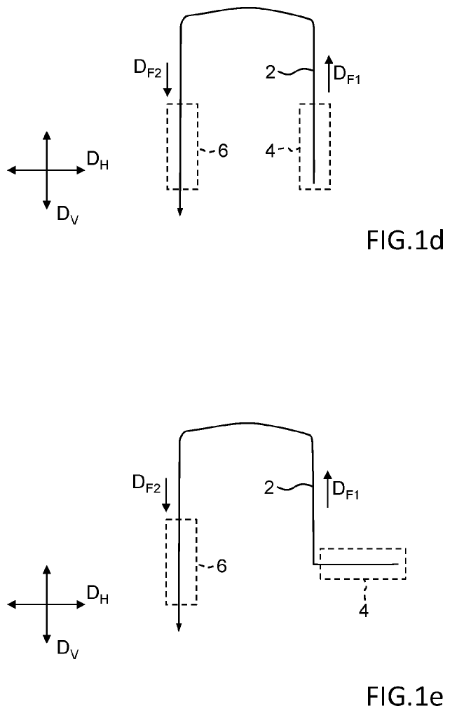

FIGS. 1a-c schematically show a product forming unit U for manufacturing non-flat cellulose products 1 from an air-formed cellulose blank structure 2. The product forming unit U has extensions in a horizontal direction or plane D_{H} and a vertical direction D_{V}. The product forming unit U comprises a buffering module 5 and a pressing module 6, as will be further described below. The cellulose products 1 are manufactured from the cellulose blank structure 2 in the product forming unit U. The cellulose blank structure 2 is provided from a suitable source and fed to the buffering module 5 and the pressing module 6. The forming of the cellulose products 1 is accomplished in the pressing module 6. With non-flat products is meant products that have an extension in three dimensions, which is different from flat products like blanks or sheets.

With an air-formed cellulose blank structure 2 according to the disclosure is meant an essentially air-formed fibrous web structure produced from cellulose fibers. The cellulose fibers may originate from a suitable cellulose raw material R, such as a pulp material. Suitable pulp materials are for example fluff pulp, paper structures, or other cellulose fiber containing structures. With air-forming of the cellulose blank structure 2 is meant the formation of a cellulose blank structure in a dry-forming process in which the cellulose fibers are air-formed to produce the cellulose blank structure 2. When forming the cellulose blank structure 2 in the air-forming process, the cellulose fibers are carried and formed to the fiber blank structure 2 by air as carrying medium. This is different from a normal papermaking process or a traditional wet-forming process, where water is used as carrying medium for the cellulose fibers when forming the paper or fiber structure. In the air-forming process, small amounts of water or other substances may if desired be added to the cellulose fibers in order to change the properties of the cellulose product, but air is still used as carrying medium in the forming process. The cellulose blank structure 2 may, if suitable have a dryness that is mainly corresponding to the ambient humidity in the atmosphere surrounding the air-formed cellulose blank structure 2. As an alternative, the dryness of the cellulose blank structure 2 can be controlled in order to have a suitable dryness level when forming the cellulose products 1.

The air-formed cellulose blank structure 2 may be formed of cellulose fibers in a conventional air-forming process or in a blank dry-forming module 4 as illustrated in FIGS. 1a-c and 2, and be configured in different ways. For example, the cellulose blank structure 2 may have a composition where the fibers are of the same origin or alternatively contain a mix of two or more types of cellulose fibers, depending on the desired properties of the cellulose products 1. The cellulose fibers used in the cellulose blank structure 2 are during the forming process of the cellulose products 1 strongly bonded to each other with hydrogen bonds. The cellulose fibers may be mixed with other substances or compounds to a certain amount as will be further described below. With cellulose fibers is meant any type of cellulose fibers, such as natural cellulose fibers or manufactured cellulose fibers. The cellulose blank structure 2 may specifically comprise at least 95% cellulose fibers, or more specifically at least 99% cellulose fibers.

The air-formed cellulose blank structure 2 may have a single-layer or a multi-layer configuration. A cellulose blank structure 2 having a single-layer configuration is referring to a structure that is formed of one layer containing cellulose fibers. A cellulose blank structure 2 having a multi-layer configuration is referring to a structure that is formed of two or more layers comprising cellulose fibers, where the layers may have the same or different compositions or configurations.

The cellulose blank structure 2 may comprise a reinforcement layer comprising cellulose fibers, where the reinforcement layer may be arranged as a carrying layer for one or more other layers of the cellulose blank structure 2. The reinforcement layer may have a higher tensile strength than other layers of the cellulose blank structure 2. This is useful when one or more air-formed layers of the cellulose blank structure 2 have compositions with low tensile strength in order to avoid that the cellulose blank structure 2 will break during the forming of the cellulose products 1. The reinforcement layer with a higher tensile strength acts in this way as a supporting structure for other layers of the cellulose blank structure 2. The reinforcement layer may be of a different composition than the rest of the cellulose blank structure, such as for example a tissue layer containing cellulose fibers, an air laid structure comprising cellulose fibers, or other suitable layer structures. It is thus not necessary that the reinforcement layer is air-formed. The cellulose blank structure 2 may comprise more than one reinforcement layer if suitable.

The cellulose blank structure 2 may further comprise one or more barrier layers giving the cellulose products the ability to hold or withstand liquids, such as for example when the cellulose products 1 are used in contact with beverages, food, and other water-containing substances. The barrier layer may be of a different composition than the rest of the cellulose blank structure 2, such as for example a tissue barrier structure.

The one or more air-formed layers of the cellulose blank structure 2 are fluffy and airy structures, where the cellulose fibers forming the structures are arranged relatively loosely in relation to each other. The fluffy cellulose blank structures 2 are used for an efficient forming of the cellulose products 1, allowing the cellulose fibers to form the cellulose products 1 in an efficient way during the forming process.

The pressing module 6 comprises one or more forming molds 3, as indicated in FIGS. 1a-b and 6a-e, and each forming mold 3 comprises a first mold part 3a and a second mold part 3b. Corresponding first and second mold parts are cooperating with each other during the forming of the non-flat cellulose products 1 in the pressing module 6. Each first mold part 3a and corresponding second mold part 3b are movably arranged in relation to each other, and the first mold part 3a and the second mold part 3b are configured for moving in relation to each other in a pressing direction D_{P}.

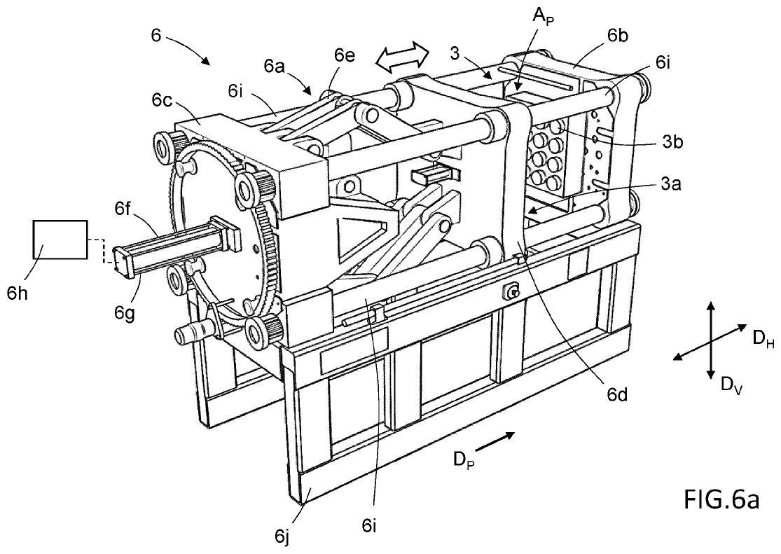

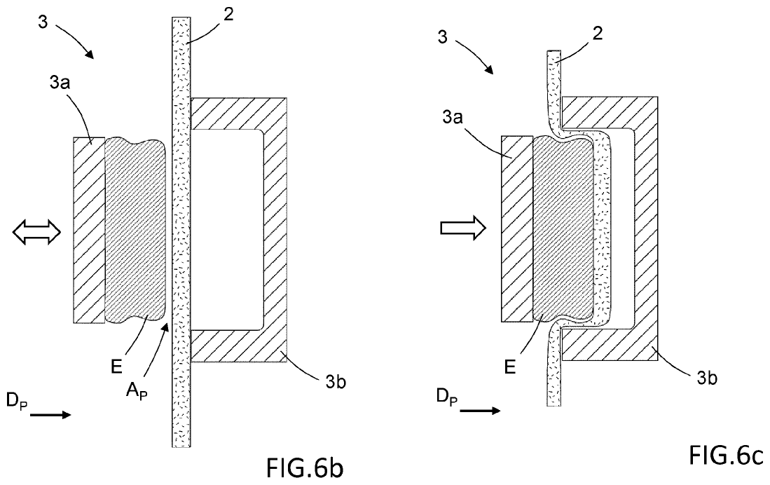

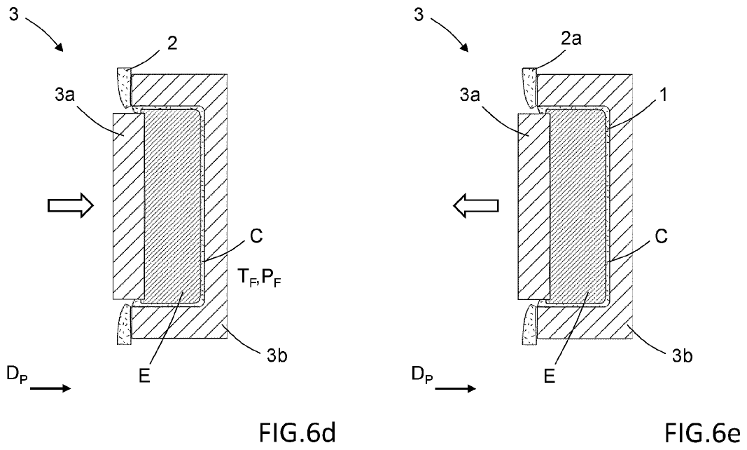

In the embodiment illustrated in FIGS. 1a-c and 6a-e, the second mold parts 3b are stationary and the first mold parts 3a are movably arranged in relation to the second mold parts 3b in the pressing direction D_{P}. As indicated with the double arrow in FIGS. 6a-b, the first mold parts 3a are configured to move both towards the second mold parts 3b and away from the second mold parts 3b in linear movements along an axis extending in the pressing direction D_{P}.

In alternative embodiments, the first mold parts 3a may be stationary with the second mold parts 3b movably arranged in relation to the first mold parts 3a, or both the first mold parts 3a and the second mold parts 3b may be movably arranged in relation to each other.

The pressing module 6 may be of a single-cavity configuration or alternatively of a multi-cavity configuration. A single-cavity pressing module comprises only one forming mold 3 with first and second mold parts. A multi-cavity pressing module comprises two or more forming molds 3, each having cooperating first and second mold parts. In the embodiment illustrated in FIGS. 1a-c and 6a, the pressing module 6 is arranged as a multi-cavity pressing module comprising a plurality of forming molds 3 with first and second mold parts, where the movements of the mold parts suitably are synchronized for a simultaneous forming operation. The part of the pressing module 6 shown in FIGS. 6b-e is illustrating the single-cavity configuration, or alternatively a section of the multi-cavity configuration with one forming mold 3. In the following, the pressing module 6 will be described in connection to a multi-cavity pressing module, but the disclosure is equally applicable on a single-cavity pressing module.

It should be understood that for all embodiments according to the disclosure, the expression moving in the pressing direction D_{P} includes a movement in the pressing direction D_{P}, and the movement may take place in opposite directions. The expression may further include both linear and non-linear movements of a mold part, where the result of the movement during forming is a repositioning of the mold part in the pressing direction D_{P}.

To form the non-flat cellulose products 1 from the air-formed cellulose blank structure 2 in the product forming unit U, the cellulose blank structure 2 is first provided from a suitable source. The cellulose blank structure 2 may be air-formed from cellulose fibers and arranged on rolls or in stacks. The rolls or stacks may thereafter be arranged in connection to the product forming unit U. As an alternative, the cellulose blank structure 2 may be air-formed from cellulose fibers in the blank dry-forming module 4 of the product forming unit U and directly fed to the pressing module 6 via the buffering module 5.

The cellulose products 1 are formed from the cellulose blank structure 2 in the one or more forming molds 3 by heating the cellulose blank structure 2 to a forming temperature T_{F} in the range of 100-300° C., and pressing the cellulose blank structure 2 with a forming pressure P_{F} in the range of 1-100 MPa, preferably 4-20 MPa. The first mold parts 3a are arranged for forming the non-flat cellulose products 1 through interaction with the corresponding second mold parts 3b, as exemplified in FIGS. 6b-e. During forming of the cellulose products 1, the cellulose blank structure 2 is in each forming mold 3 exerted to the forming pressure P_{F} in the range of 1-100 MPa, preferably in the range of 4-20 MPa, and the forming temperature T_{F} in the range of 100-300° C. The cellulose products 1 are thus formed from the cellulose blank structure 2 between each of the first mold parts 3a and corresponding second mold parts 3b by heating the cellulose blank structure 2 to the forming temperature T_{F} in the range of 100-300° C., and by pressing the cellulose blank structure 2 with the forming pressure P_{F} in the range of 1-100 MPa, preferably in the range of 4-20 MPa. When forming the cellulose products 1, strong hydrogen bonds are formed between the cellulose fibers in the cellulose blank structure 2 arranged between the first mold parts 3a and the second mold parts 3b. The temperature and pressure levels are for example measured in the cellulose blank structure 2 during the forming process with suitable sensors arranged in or in connection to the cellulose fibers in the cellulose blank structure 2.

The pressing module 6 may further comprises a heating unit. The heating unit is configured for applying the forming temperature T_{F} onto the cellulose blank structure 2 in each forming mold 3. The heating unit may have any suitable configuration. The heating unit may be integrated in or cast into the first mold parts 3a and/or the second mold parts 3b, and suitable heating devices are e.g. electrical heaters, such as a resistor element, or fluid heaters. Other suitable heat sources may also be used.

When the cellulose blank structure 2 is arranged in a forming position between the first mold parts 3a and the second mold parts 3b, as shown in FIG. 6b, the first mold parts 3a are moved towards the second mold parts 3b in the pressing direction D_{P}, as illustrated with the arrow in FIG. 6c. Upon movement of the first mold parts 3a towards the second mold parts 3b, the cellulose blank structure 2 is being increasingly compacted between the mold parts, until the first mold parts 3a have been further moved towards the second mold parts 3b and reached a product forming position, as shown in FIG. 6d, in which the forming pressure P_{F} and forming temperature T_{F} is exerted onto the cellulose blank structure 2. A forming cavity C for forming the cellulose products 1 is formed between each first mold part 3a and second mold part 3b during forming of the cellulose products 1 when each first mold part 3a is pressed towards its corresponding second mold part 3b with the cellulose blank structure 2 arranged between the mold parts. The forming pressure P_{F} and the forming temperature T_{F} are applied to the cellulose blank structure 2 in each forming cavity C. The forming of the cellulose products 1 may further include an edge-forming operation and a cutting or separation operation in the pressing module 6, where edges are formed on the cellulose products 1 and where the cellulose products 1 are separated from the cellulose blank structure 2 during forming of the cellulose products 1. The mold parts may for example be arranged with edge-forming devices and cutting or separation devices for such operations, or alternatively the edges may be formed in the product cutting or separation operation. Once the cellulose products 1 have been formed in the pressing module 6, the first mold parts 3a are moved in a direction away from the second mold parts 3b, as shown in FIG. 6e, and the cellulose products 1 can be removed from the pressing module 6, for example by using ejector rods or similar devices.

A pressure distribution element E for establishing the forming pressure may be arranged in connection to each first mold part 3a and/or second mold part 3b. In the embodiment illustrated in FIGS. 6b-e, the pressure distribution element E is attached to the first mold part 3a. The pressure distribution element E is deformed when exerted to pressure, and by arranging the pressure distribution element E in connection to a mold part, the forming pressure P_{F} may be configured as an equalized forming pressure where the pressure in the forming mold 3 is efficiently distributed in different directions. The pressure distribution element E is enabling a forming pressure distribution in the forming mold 3 not only in the pressing direction D_{P}, but also in directions different from the pressing direction D_{P}, such as directions between the pressing direction D_{P} and directions perpendicular to the pressing direction D_{P}. The equalized forming pressure may include an isostatic forming pressure.

The first mold parts 3a and/or the second mold parts 3b may comprise pressure distribution elements E and the pressure distribution elements E are configured for exerting the forming pressure P_{F} on the cellulose blank structure 2 in the forming cavities C during forming of the cellulose products 1. The pressure distribution elements E may be attached to the first mold parts 3a and/or the second mold parts 3b with suitable attachment means, such as for example glue or mechanical fastening members. During the forming of the cellulose products 1, the pressure distribution elements E are deformed to exert the forming pressure P_{F} on the cellulose blank structure 2 in the forming cavities C and through deformation of the pressure distribution elements E, an equalized pressure distribution is achieved even if the cellulose products 1 are having complex three-dimensional shapes or if the cellulose blank structure 2 is having a varied thickness. To exert a required forming pressure P_{F} on the cellulose blank structure 2, the pressure distribution elements E are made of a material that can be deformed when a force or pressure is applied, and the pressure distribution elements E are suitably made of an elastic material capable of recovering size and shape after deformation. The pressure distribution elements E may further be made of a material with suitable properties that is withstanding the high forming pressure P_{F} and forming temperature T_{F} levels used when forming the cellulose products 1.

Certain elastic or deformable materials have fluid-like properties when being exposed to high pressure levels. If the pressure distribution elements E are made of such a material or combinations of such materials, an equalized pressure distribution can be achieved in the forming process. Each pressure distribution element E may be made of a suitable structure of elastomeric material or materials, and as an example, the pressure distribution element E may be made of a structure of gel materials, silicone rubber, polyurethane, polychloroprene, rubber, or a combination of different suitable materials.

The product forming unit U shown in FIGS. 1a-c comprises the buffering module 5 and the pressing module 6. The product forming unit U is adapted for feeding the cellulose blank structure 2 to the buffering module 5, buffering the cellulose blank structure 2 in the buffering module 5, and feeding the cellulose blank structure 2 from the buffering module 5 to the pressing module 6. The product forming unit U is further adapted for forming the non-flat cellulose products 1 from the cellulose blank structure 2 in the one or more forming molds 3 by heating the cellulose blank structure 2 to the forming temperature T_{F}, and pressing the cellulose blank structure 2 with the forming pressure P_{F}. As described above, the one or more forming molds 3 are configured for forming the non-flat cellulose products 1 from the cellulose blank structure 2 by heating the cellulose blank structure 2 to the forming temperature T_{F} in the range of 100-300° C., and pressing the cellulose blank structure 2 with a forming pressure P_{F} in the range of 1-100 MPa, preferably 4-20 MPa.

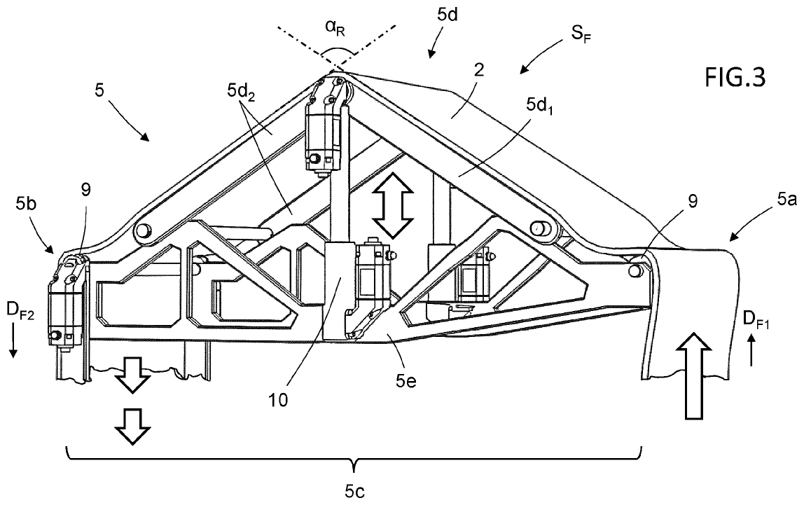

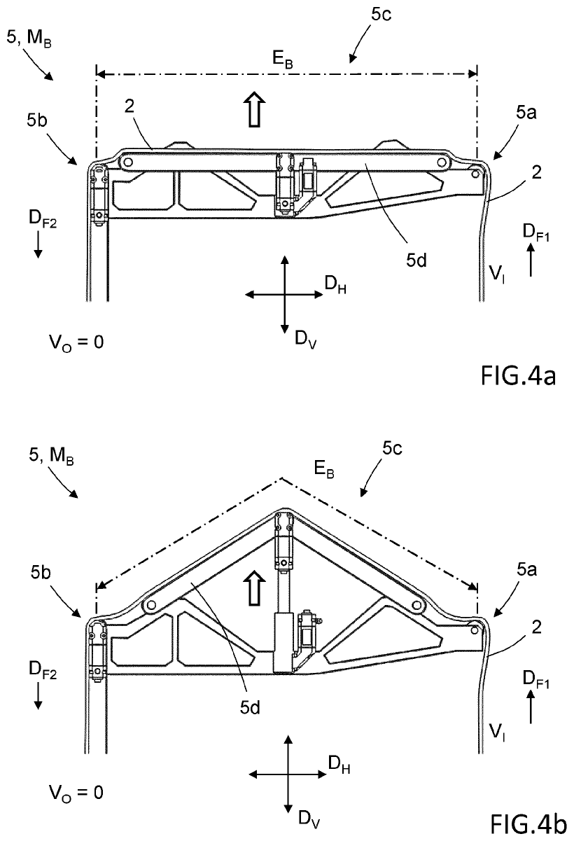

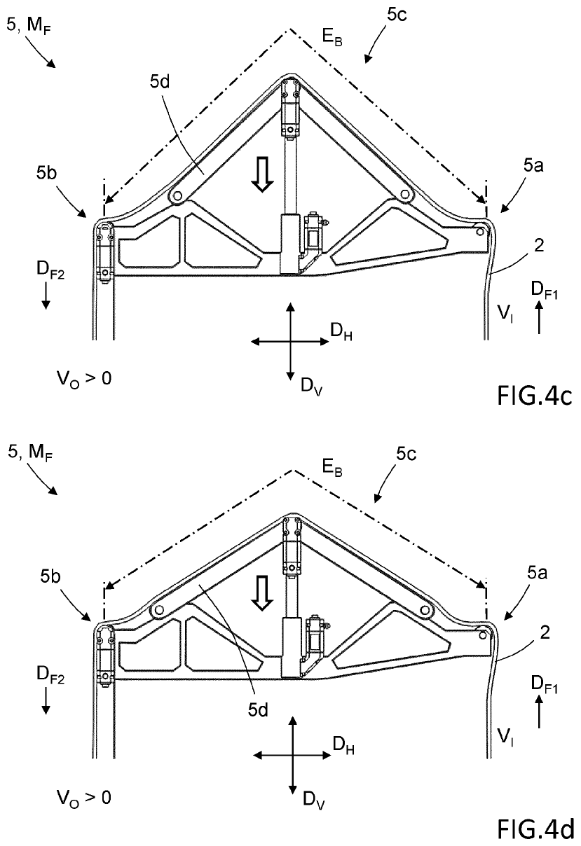

The buffering module 5 is as illustrated in for example FIG. 1 arranged upstream the pressing module 6, and the buffering module 5 has the purpose to convert the feeding mode of the cellulose blank structure 2 from continuous feeding to intermittent feeding. Due to the relatively brittle structural properties of the cellulose blank structure 2, a continuous feeding from the cellulose blank structure source is suitable. However, due to the intermittent operation of the pressing module 6, the continuous feeding needs to be converted to intermittent feeding without breaking the cellulose blank structure 2. To achieve this, the buffering module 5 comprises a blank feeding system SF configured for continuously feeding the cellulose blank structure 2 to the buffering module 5, and intermittently feeding the cellulose blank structure 2 from the buffering module 5, as shown in FIGS. 3, 4a-d, and 5a-e. The blank feeding system SF is further configured for continuously feeding the cellulose blank structure 2 to the buffering module 5 in a first feeding direction D_{F1}, and intermittently feeding the cellulose blank structure 2 from the buffering module 5 in a second feeding direction D_{F2}, where the second feeding direction D_{F2} differs from the first feeding direction D_{F1}. The differing first feeding direction D_{F1} and second feeding direction D_{F2} are allowing a compact configuration and layout of the product forming unit U, and an efficient and compact positioning of the different modules of the product forming unit U in relation to each other. During operation of the product forming unit U, the cellulose blank structure 2 is buffered in the buffering module 5, and fed from the buffering module 5 to the pressing module 6. The cellulose blank structure 2 is continuously fed to the buffering module 5 in the first feeding direction D_{F1}, and intermittently fed from the buffering module 5 in the second feeding direction D_{F2}.

In certain embodiments, the first feeding direction D_{F1} is opposite to, or essentially opposite to, the second feeding direction D_{F2}, as for example shown in the embodiments illustrated in FIGS. 3, 4a-d, and 5a-e. In the illustrated embodiments, the first feeding direction D_{F1} is an upwards direction and the second feeding direction D_{F2} is a downwards direction, which is allowing a compact and efficient configuration of the product forming unit U.

The buffering module 5 comprises an inlet portion 5a, an outlet portion 5b, and a buffering portion 5c between the inlet portion 5a and the outlet portion 5b, as shown in FIGS. 3, 4a-d, and 5a-e. The cellulose blank structure 2 is arranged with a buffering extension E_{B} in the buffering portion 5c between the inlet portion 5a and the outlet portion 5b. The buffering extension E_{B} of the cellulose blank structure 2 is measured as the length extension of the cellulose blank structure 2 between the inlet portion 5a and the outlet portion 5b. The buffering portion 5c is configured for gradually increasing the buffering extension E_{B} of the cellulose blank structure 2 during a buffering mode M_{B}, and gradually decreasing the buffering extension E_{B} of the cellulose blank structure 2 during a feeding mode MF.

In the embodiments illustrated in FIGS. 3, 4a-d and 5a-c, the buffering portion 5c comprises a guide member 5d. The guide member 5d is arranged between the inlet portion 5a and the outlet portion 5b. As shown more in detail in FIG. 3, the guide member 5d comprises a first arm section 5d1 and a second arm section 5d2 configured for intermittently varying the buffering extension E_{B} in the buffering mode M_{B} and the feeding mode MF respectively. The arm sections or other parts of the buffering module 5 may be arranged with supporting plates, belts, or other suitable structures for a correct positioning of the cellulose blank structure 2 during feeding, where the supporting plates, belts, or structures may be arranged to move with the arm sections. An actuator 10 is connected to the first arm section 5d₁ and the second arm section 5d₂, and the actuator 10 is arranged for displacing the first arm section 5d₁ and the second arm section 5d₂ for varying the buffering extension E_{B}. In this way, the buffering portion 5c is configured for varying an angular relationship α_{R} between the first arm section 5d₁ and the second arm section 5d₂ in the buffering mode M_{B} and the feeding mode MF for varying the buffering extension E_{B}, as understood from FIGS. 3 and 4a-d. The actuator may be of any suitable type, such as for example a hydraulic or pneumatic piston actuator, or an electric actuator.

In FIG. 4a, the buffering module 5 is arranged in a starting position, in which the buffering mode M_{B} is started. From the starting position in FIG. 4a, the actuator 10 is displacing the first arm section 5d₁ and the second arm section 5d₂ in an upwards direction, as indicated with the arrow. In FIG. 4b, the length of the cellulose blank structure 2 has through the impact from the first arm section 5d₁ and the second arm section 5d₂ increased, and thus the buffering extension E_{B} is increasing in the buffering mode M_{B}. Upon further movement of the first arm section 5d₁ and the second arm section 5d₂, the buffering extension E_{B} is further increasing to an end position of the buffering module 5 shown in FIG. 4c. When the first arm section 5d₁ and the second arm section 5d₂ have reached the end position, the actuator 10 is thereafter displacing the first arm section 5d₁ and the second arm section 5d₂ in a downwards direction as indicated with the arrow in FIG. 4c. The downwards displacement is starting the feeding mode MF, and in the feeding mode MF the buffering extension E_{B} is decreasing. In FIG. 4d, the length of the cellulose blank structure 2 has through the impact from the first arm section 5d₁ and the second arm section 5d₂ decreased. The feeding mode MF ends when the first arm section 5d₁ and the second arm section 5d₂ have returned to the position shown in FIG. 4a, in which position a buffering cycle including the buffering mode M_{B} and the feeding mode MF can start again in the same way as described above. It should be noted that upwards and downwards are in this context relating to the orientation of the buffering module 5 in the embodiments illustrated in the figures. In other embodiments, the orientation of the buffering module 5 may be different.

In the embodiments illustrated in FIGS. 3 and 4a-d, the blank feeding system SF comprises a blank feeding roller 9 arranged in connection to the inlet portion 5a, and a blank feeding roller 9 in connection to or downstream the outlet portion 5b. The blank feeding rollers 9 are used for feeding the cellulose blank structure 2 into the buffering module and away from the buffering module. The blank feeding roller 9 arranged in connection to the inlet portion 5a is suitably continuously driven with a non-illustrated drive source, such as an electric motor or similar device. The blank feeding roller 9 arranged in connection to the outlet portion 5b is intermittently driven with a suitable drive source, such as an electric motor or similar device, and controlled by a control system. The blank feeding rollers 9 are suitably arranged as tractor feeding rollers engaging the cellulose blank structure 2. Other types of blank feeding rollers may also be used. In this way, the blank feeding system SF is configured for continuously feeding the cellulose blank structure 2 to the inlet portion 5a and intermittently feeding the cellulose blank structure 2 from the outlet portion 5b when the guide member 5d is activated. During activation of the guide member 5d in the buffering mode M_{B}, a buffer of the cellulose blank structure 2 is built in the buffering portion 5c, and during activation of the guide member 5d in the feeding mode MF the buffer of the cellulose blank structure 2 is released from the buffering portion 5c, as described above in connection to FIGS. 4a-d. In the embodiments illustrated in FIGS. 3 and 4a-d, the cellulose blank structure 2 is through the arrangement with the feeding rollers 9 continuously fed to the buffering module 5 in the first feeding direction D_{F1} in direct connection to the buffering module 5, and intermittently fed from the buffering module 5 in the second feeding direction D_{F2} in direct connection to the buffering module 5, as understood from the figures.

The feeding rollers 9 may each be arranged as a pair of cooperating rollers with the cellulose blank structure 2 arranged in-between, instead of single rollers. In alternative non-illustrated embodiments, the blank feeding rollers 9 may instead be arranged upstream the inlet portion 5a, and/or downstream the outlet portion 5b.

For all embodiments, the cellulose blank structure 2 is intermittently fed from the buffering module 5 to the pressing module 6. The buffering module 5 is configured for alternatingly operating in the buffering mode M_{B} and the feeding mode MF. The cellulose blank structure 2 is fed to the buffering module 5 in the buffering mode M_{B} and the feeding mode MF with a continuous input speed Vi, as indicated in FIGS. 4a-d. The cellulose blank structure 2 is fed from the buffering module 5 in the buffering mode M_{B} with an output speed Vo lower than the output speed Vo of the cellulose blank structure 2 from the buffering module 5 in the feeding mode MF, for an intermittent feeding operation. Suitably, the output speed Vo in the buffering mode M_{B} is zero, or the output speed Vo in the buffering mode M_{B} is essentially zero.

The buffering module 5 may further comprises a first blank redirecting device 5e₁ arranged upstream the inlet portion 5a and/or a second blank redirecting device 5e₂ arranged downstream the outlet portion 5b.

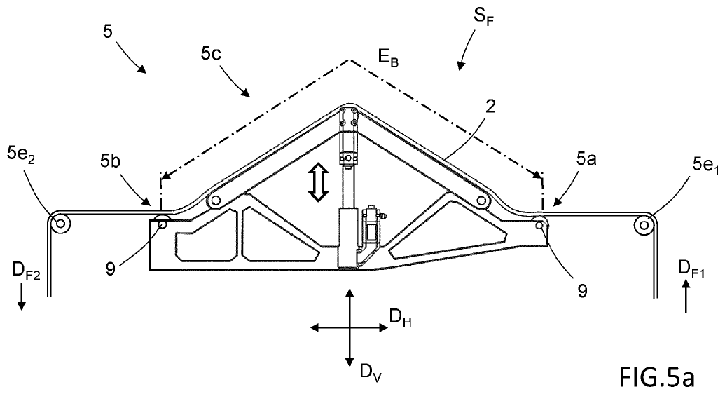

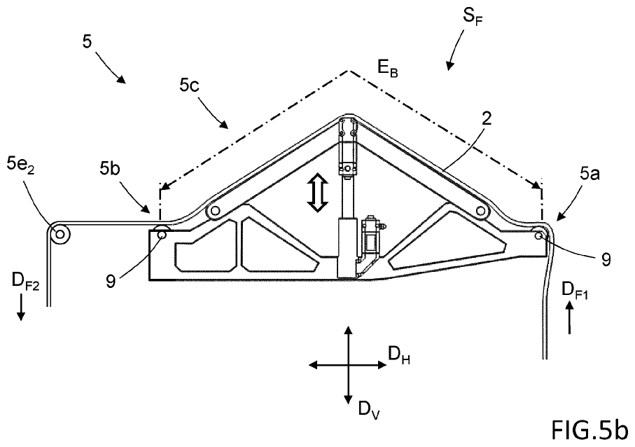

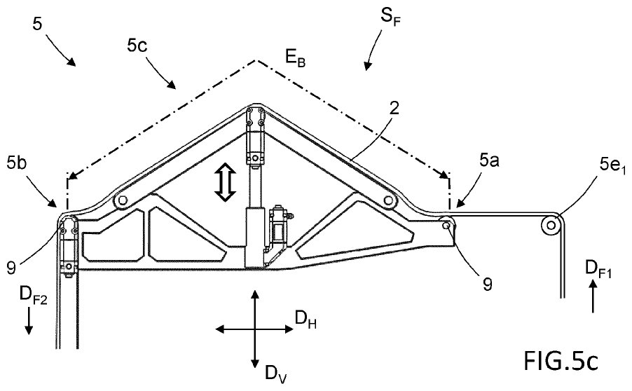

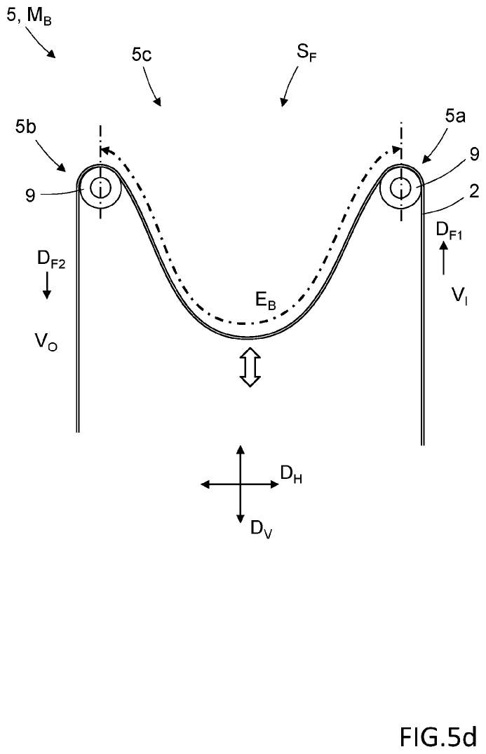

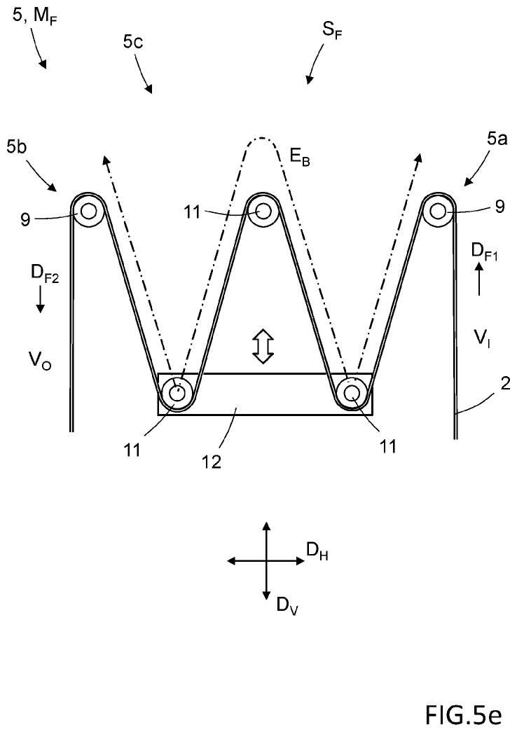

In FIG. 5a, an alternative embodiment of the buffering module 5 is illustrated, where the buffering module is operated in a similar way as described above in connection to the embodiment in FIGS. 3 and 4a-d. A first blank redirecting device 5e₁ is arranged upstream the inlet portion 5a and a second blank redirecting device 5e₂ is arranged downstream the outlet portion 5b. The respective redirecting devices are suitably arranged as rollers that are altering the direction of the cellulose blank structure 2. With the configuration in FIG. 5a, the cellulose blank structure 2 is continuously fed to the buffering module 5 in the first feeding direction D_{F1}, and thereafter redirected in the first blank redirecting device 5e₁ and fed to the feeding roller 9 at the inlet portion 5a. The cellulose blank structure 2 is intermittently fed from the buffering module 5 at the second blank redirecting device 5e₂ in the second feeding direction D_{F2}. The cellulose blank structure 2 is fed from the feeding roller 9 at the outlet portion 5b to the second blank redirecting device 5e₂, where the cellulose blank structure is redirected to the second feeding direction D_{F2}. As understood from the figure, the second feeding direction D_{F2} differs from the first feeding direction D_{F1} for a compact configuration of the product forming unit U. The feeding rollers 9 are suitably driven as described in the embodiment above.

In FIG. 5b, an alternative embodiment of the buffering module 5 is illustrated, where the buffering module is operated in a similar way as described above in connection to the embodiment in FIGS. 3 and 4a-d. A second blank redirecting device 5e₂ is arranged downstream the outlet portion 5b. The redirecting device is suitably arranged as a roller that is altering the direction of the cellulose blank structure 2. With the configuration in FIG. 5b, the cellulose blank structure 2 is continuously fed to the buffering module 5 in the first feeding direction D_{F1} to the feeding roller 9 at the inlet portion 5a. The cellulose blank structure 2 is intermittently fed from the buffering module 5 at the second blank redirecting device 5e₂ in the second feeding direction D_{F2}. The cellulose blank structure 2 is fed from the feeding roller 9 at the outlet portion 5b to the second blank redirecting device 5e₂, where the cellulose blank structure is redirected to the second feeding direction D_{F2}. As understood from the figure, the second feeding direction D_{F2} differs from the first feeding direction D_{F1} for a compact configuration of the product forming unit U. The feeding rollers 9 are suitably driven as described in the embodiment above.

In FIG. 5c, an alternative embodiment of the buffering module 5 is illustrated, where the buffering module is operated in a similar way as described above in connection to the embodiment in FIGS. 3 and 4a-d. A first blank redirecting device 5e₁ is arranged upstream the inlet portion 5a. The redirecting device is suitably arranged as a roller that is altering the direction of the cellulose blank structure 2. With the configuration in FIG. 5c, the cellulose blank structure 2 is continuously fed to the buffering module 5 in the first feeding direction D_{F1}, and thereafter redirected in the first blank redirecting device 5e₁ and fed to the feeding roller 9 at the inlet portion 5a. The cellulose blank structure 2 is intermittently fed from the buffering module 5 at the feeding roller 9 arranged at the outlet portion 5b. As understood from the figure, the second feeding direction D_{F2} differs from the first feeding direction D_{F1} for a compact configuration of the product forming unit U. The feeding rollers 9 are suitably driven as described in the embodiments above.

In FIG. 5d a further alternative embodiment of the buffering module 5 is illustrated. In this embodiment, the buffering module 5 is arranged without the guide member. The buffering module 5 comprises an inlet portion 5a, an outlet portion 5b, and a buffering portion 5c between the inlet portion 5a and the outlet portion 5b. The cellulose blank structure 2 is arranged with a buffering extension E_{B} in the buffering portion 5c between the inlet portion 5a and the outlet portion 5b. The buffering extension E_{B} of the cellulose blank structure 2 is measured as the length extension of the cellulose blank structure 2 between the inlet portion 5a and the outlet portion 5b. The buffering portion 5c is configured for gradually increasing the buffering extension E_{B} of the cellulose blank structure 2 during a buffering mode M_{B}, and gradually decreasing the buffering extension E_{B} of the cellulose blank structure 2 during a feeding mode MF. The buffering module 5 comprises a blank feeding system SF configured for continuously feeding the cellulose blank structure 2 to the buffering module 5, and intermittently feeding the cellulose blank structure 2 from the buffering module 5. In the same way as described above, the blank feeding system SF is further configured for continuously feeding the cellulose blank structure 2 to the buffering module 5 in a first feeding direction D_{F1}, and intermittently feeding the cellulose blank structure 2 from the buffering module 5 in a second feeding direction D_{F2}, where the second feeding direction D_{F2} differs from the first feeding direction D_{F1}.

In the embodiment illustrated in FIG. 5d, the blank feeding system SF comprises a blank feeding roller 9 arranged in connection to the inlet portion 5a, and a blank feeding roller 9 in connection to the outlet portion 5b. The blank feeding rollers 9 are used for feeding the cellulose blank structure 2 into the buffering module and away from the buffering module. The blank feeding roller 9 arranged in connection to the inlet portion 5a is suitably continuously driven with a non-illustrated drive source, such as an electric motor or similar device. The blank feeding roller 9 arranged in connection to the outlet portion 5b is intermittently driven with a suitable drive source, such as an electric motor or similar device, and controlled by a control system. In this way, the blank feeding system SF is configured for continuously feeding the cellulose blank structure 2 to the inlet portion 5a and intermittently feeding the cellulose blank structure 2 from the outlet portion 5b through activation of the feeding rollers 9. During activation of the feeding rollers 9 in the buffering mode M_{B}, a buffer of the cellulose blank structure 2 is built in the buffering portion 5c, and during activation of the feeding rollers 9 in the feeding mode MF the buffer of the cellulose blank structure 2 is released from the buffering portion 5c. During buffering, the cellulose blank structure 2 is allowed to hang down between the rollers, as understood from FIG. 5d. In the embodiment illustrated in FIG. 5d, the cellulose blank structure 2 is through the arrangement with the feeding rollers 9 continuously fed to the buffering module 5 in the first feeding direction D_{F1}, and intermittently fed from the buffering module 5 in the second feeding direction D_{F2}. The feeding rollers 9 may each alternatively be arranged as a pair of cooperating rollers with the cellulose blank structure 2 arranged in-between, instead of single rollers.

In FIG. 5e a further alternative embodiment of the buffering module 5 is illustrated. The buffering module 5 comprises an inlet portion 5a, an outlet portion 5b, and a buffering portion 5c between the inlet portion 5a and the outlet portion 5b. The cellulose blank structure 2 is arranged with a buffering extension E_{B} in the buffering portion 5c between the inlet portion 5a and the outlet portion 5b. The buffering extension E_{B} of the cellulose blank structure 2 is measured as the length extension of the cellulose blank structure 2 between the inlet portion 5a and the outlet portion 5b. The buffering portion 5c is configured for gradually increasing the buffering extension E_{B} of the cellulose blank structure 2 during a buffering mode M_{B}, and gradually decreasing the buffering extension E_{B} of the cellulose blank structure 2 during a feeding mode MF. The buffering module 5 comprises a blank feeding system SF configured for continuously feeding the cellulose blank structure 2 to the buffering module 5, and intermittently feeding the cellulose blank structure 2 from the buffering module 5. In the same way as described above, the blank feeding system SF is further configured for continuously feeding the cellulose blank structure 2 to the buffering module 5 in a first feeding direction D_{F1}, and intermittently feeding the cellulose blank structure 2 from the buffering module 5 in a second feeding direction D_{F2}, where the second feeding direction D_{F2} differs from the first feeding direction D_{F1}.

In the embodiment illustrated in FIG. 5d, the blank feeding system SF comprises a blank feeding roller 9 arranged in connection to the inlet portion 5a, and a blank feeding roller 9 in connection to the outlet portion 5b. The blank feeding rollers 9 are used for feeding the cellulose blank structure 2 into the buffering module and away from the buffering module. The blank feeding roller 9 arranged in connection to the inlet portion 5a is suitably continuously driven with a non-illustrated drive source, such as an electric motor or similar device. The blank feeding roller 9 arranged in connection to the outlet portion 5b is intermittently driven with a suitable drive source, such as an electric motor or similar device, and controlled by a control system. In this way, the blank feeding system SF is configured for continuously feeding the cellulose blank structure 2 to the inlet portion 5a and intermittently feeding the cellulose blank structure 2 from the outlet portion 5b through activation of the feeding rollers 9. During activation of the feeding rollers 9 in the buffering mode M_{B}, a buffer of the cellulose blank structure 2 is built in the buffering portion 5c, and during activation of the feeding rollers 9 in the feeding mode MF the buffer of the cellulose blank structure 2 is released from the buffering portion 5c. The blank feeding system SF of the embodiment in FIG. 5e further comprises intermediate rollers 11 configured for buffering the cellulose blank structure 2 in the buffering portion 5c. Two lower intermediate rollers 11 are arranged on a buffering actuator 12 that is arranged to move towards and away from an upper intermediate roller 11. During buffering, the buffering actuator 12 is moving away from the upper intermediate roller 11. When releasing the cellulose blank structure 2, the buffering actuator 12 is moving towards the upper intermediate roller 11. In this way, the buffering extension E_{B} can be altered. The buffering actuator may be displaced with suitable displacement means, such as for example a linear actuator or similar device. In the embodiment illustrated in FIG. 5d, the cellulose blank structure 2 is through the arrangement with the feeding rollers 9 and the intermediate rollers 11 continuously fed to the buffering module 5 in the first feeding direction D_{F1}, and intermittently fed from the buffering module 5 in the second feeding direction D_{F2}. The feeding rollers 9 and the intermediate rollers 11 may each alternatively be arranged as a pair of cooperating rollers with the cellulose blank structure 2 arranged in-between, instead of single rollers. It should be noted that upper and lower are in this context relating to the orientation of the buffering module 5 in the embodiment illustrated in the figure. In other embodiments, the orientation of the buffering module 5 may be different.

For the different embodiments, the buffering module 5 may further comprise sensors and feedback systems for measuring and controlling the cellulose blank structure 2 in the buffering module. Stationary or moving supporting plates, belts, or other suitable structures may be used for a correct positioning of the cellulose blank structure 2 during feeding in the buffering module 5.

The pressing module 6 is for example illustrated in FIG. 6a. In the illustrated embodiment, the pressing module 6 is a cellulose product toggle pressing module for forming the non-flat cellulose products 1 from the cellulose blank structure 2. The cellulose product toggle pressing module comprises the one or more forming molds 3, as indicated in FIGS. 1a-b and 6a-e, and each forming mold 3 comprises the first mold part 3a and a second mold part 3b.

The pressing module 6 comprises a toggle press 6a and the one or more forming molds 3. The toggle press 6a includes a front structure 6b, a rear structure 6c, and a pressing member 6d movably arranged in the pressing direction D_{P}. A toggle-mechanism 6e is drivingly connected to the pressing member 6d. A pressing actuator arrangement 6f is drivingly connected to the toggle-mechanism 6e, and an electronic control system 6h is operatively connected to the pressing actuator arrangement 6f, and the one or more forming molds 3. The one or more forming molds 3 include the moveable first forming mold parts 3a attached to the pressing member 6d and the stationary second forming mold parts 3b. The electronic control system 6h is configured for controlling operation of the pressing actuator arrangement 6f for driving the pressing member 6d using the toggle-mechanism 6e in the pressing direction D_{P} and forming the non-flat cellulose product 1 from the cellulose blank structure 2 by pressing the first forming mold part 3a against the stationary second forming mold part 3b, as described above. The toggle press 6a is installed with, or arranged for being installed with, the pressing direction D_{P} of the pressing member 6d arranged primarily in the horizontal direction D_{H}, specifically with the pressing direction D_{P} of the pressing member 6d arranged within 20 degrees from the horizontal direction D_{H}, and more specifically with the pressing direction D_{P} in parallel with the horizontal direction D_{H}.

The pressing member 6d is arranged between the front structure 6b and the rear structure 6c. The toggle-mechanism 6e is connected to the rear structure 6c and to the pressing member 6d. The pressing actuator arrangement 6f is connected to the toggle-mechanism 6e, and the pressing actuator arrangement 6f is configured for driving the pressing member 6d in the pressing direction D_{P} towards the front structure 6b by using the toggle-mechanism 6e. The pressing actuator arrangement 6f is further configured for driving the pressing member 6d away from the front structure 6b by using the toggle-mechanism 6e when the cellulose products 1 have been formed in the one or more forming molds 3. The toggle press 6a further includes a pressing force indicating arrangement 6g, and an electronic control system 6h operatively connected to the pressing actuator arrangement 6f and the pressing force indicating arrangement 6g. The electronic control system 6h is configured for controlling an operation of the pressing member 6d. The one or more forming molds 3, each comprises a first mold part 3a attached to the pressing member 6d and a second mold part 3b attached to the front structure 6b. The first and second mold parts 3a,3b are configured to jointly form the non-flat cellulose products 1 from the cellulose blank structure 2 when being pressed together.

When forming the cellulose products 1, the cellulose blank structure 2 is fed into a pressing area A_{P} defined by the first mold parts 3a and the second mold parts when being spaced apart, as exemplified in FIG. 6b. The operation of the pressing actuator arrangement 6f is controlled by means of the electronic control system 6h for driving the pressing member 6d in the pressing direction D_{P} towards the front structure 6b by using the toggle-mechanism 6e. In this way, each of the first mold parts 3a and second mold parts 3b jointly form the non-flat cellulose product 1 from the cellulose blank structure 2 when being pressed together.

The pressing actuator arrangement 6f may for example include a single or a plurality of hydraulic or pneumatic linear actuators, such as cylinder-piston actuators. Alternatively, a motor with a rotating output shaft, such as an electric, hydraulic or pneumatic motor may be used for driving a mechanical actuator, or the pressing actuator arrangement 6f may include a high-torque electric motor that is drivingly connected to the toggle-mechanism 6e via a rotary-to-linear transmission device.

The moveable first mold part 3a may be attached directly or indirectly to the pressing member 6d. This means that there may for example be an intermediate member arranged between moveable first mold part 3a and the pressing member 6d, for example a load cell for detecting pressing force, or the like. The stationary second mold part 3b is typically stationary during the pressing action but may nevertheless be adjustable in the pressing direction D_{P} in the time period between consecutive pressing actions. In the illustrated embodiment, the toggle press 6a includes the front structure 6b and the rear structure 6c, where the toggle-mechanism 6e is connected also to the rear structure 6c, and the stationary second mold part 3b is attached to the front structure 6b. The stationary second mold part 3b may be attached directly or indirectly to the front structure 6b. This means that there may for example be an intermediate member arranged between stationary second mold part 3b and the front structure 6b, for example a load cell for detecting pressing force, or the like.

The front structure 6b and the rear structures 6c represent two rigid and structurally relevant parts that must be interconnected by some kind of structurally rigid construction for ensuring that the front and rear structures do not separate from each other during pressing action. The front and rear structures may have many different forms, depending on the specific design of the pressing module 6. For example, the front and rear structures may have a plate-like shape, in particular rectangular plate-like shape, thereby enabling cost-effective manufacturing and the possibility of using the corner regions of the plate-shaped front and rear structures for attachment to a common rigid frame structure defined by the front structure 6b, the rear structure 6c, and an intermediate frame structure that connects the front structure 6b with the rear structure 6c. In some example embodiments, the toggle press 6a comprises a rigid frame structure defined by the front structure 6b, the rear structure 6c, and an intermediate linear guiding arrangement 6i that connects the front structure 6b with the rear structure 6c. The pressing member 6d is movably attached to the linear guiding arrangement 6i and moveable in the pressing direction D_{P}. The rigid frame structure may be positioned on an underlying support frame 6j for providing the desired height and angular inclination of the pressing module 6.

For enabling cost-effective and strong frame structure of the toggle press 6a, the intermediate linear guiding arrangement 6i may comprises four tie bars, arranged in each corner region of the plate-shaped front structure 6b and rear structure 6c. The tie bars are for example cylindrical and corresponding cylindrical holes may be provided in the corner regions of the plate-shaped front structure 6b and rear structure 6c for receiving said tie bars. The pressing member 6d may have any structural shape. However, in some example embodiments, also the pressing member has at least partly a plate-like shape, in particular a rectangular plate-like shape, thereby enabling cost-effective manufacturing and the possibility of using the corner regions of the plate-shaped pressing member 6d for attachment to the intermediate linear guiding arrangement 6i. Hence, the toggle press 6a may in some example embodiments be referred to as a three platen press.

The toggle press 6a is installed with, or arranged for being installed with, the pressing direction D_{P} of the pressing member 6d arranged primarily in the horizontal direction D_{H}, specifically with the pressing direction D_{P} of the pressing member 6d arranged within 20 degrees from the horizontal direction D_{H}, and more specifically with the pressing direction D_{P} in parallel with the horizontal direction D_{H}.

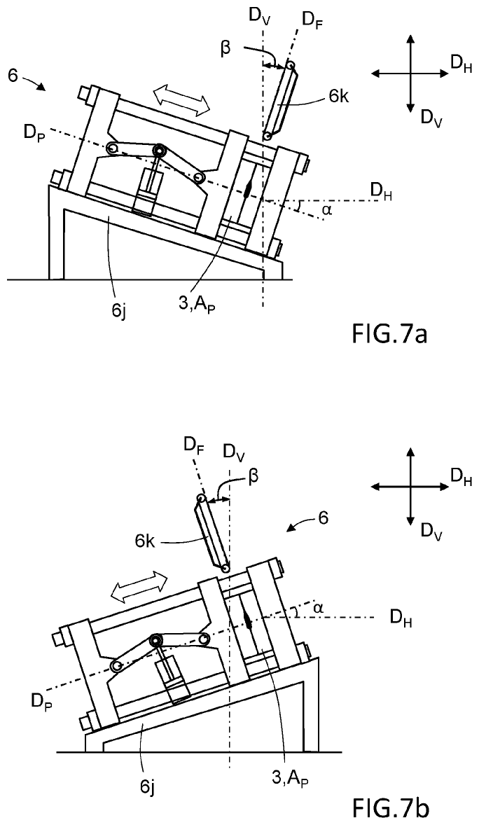

In the embodiment illustrated in FIGS. 1a-c and 6a, the toggle press 6a is installed with the pressing direction D_{P} of the pressing member 6d arranged in the horizontal direction D_{H}. In the embodiments illustrated in FIGS. 7a-b, the toggle press 6a is installed in a slightly inclined state enabling a compact overall design of the product forming unit U, with a low build-height. The toggle press 6a in the embodiments shown in FIGS. 7a-b is installed with the pressing direction D_{P} of the pressing member 6d arranged with an installation angle α in the range of 0-20 degrees, wherein said installation angle α is defined by the pressing direction D_{P} and the horizontal direction D_{H}, as illustrated in the figures.

In some example embodiments, the toggle press 6a further includes a feeding device 6k for feeding the cellulose blank structure 2 into the one or more forming molds 3 in a primarily vertical feeding direction D_{F}. The feeding device 6k is arranged for feeding the cellulose blank structure 2 into the pressing area A_{P}, specifically for feeding the cellulose blank structure 2 downwards with a feeding angle ß of less than 20 degrees from the vertical direction D_{V} into the pressing area A_{P}, and more specifically for feeding the air-formed cellulose blank structure vertically downwards into the pressing area A_{P}. The feeding angle β is schematically illustrated in FIGS. 7a-b.

As described above, the terms primarily horizontal and primarily horizontally means a direction that is arranged more horizontal than vertical. The terms primarily vertical and primarily vertically means a direction that is arranged more vertical than horizontal.

The toggle-mechanism 6e of the toggle press 6a may have a large variety of designs and implementations. The basic requirement of the toggle-mechanism 6e is to generate a pressing force amplification, thereby enabling the use of a relatively low-cost and low-capacity pressing actuator arrangement 6f in term of pressing force. The pressing force amplification is accomplished by a corresponding reduction of pressing speed of the pressing module. Hence, the toggle-mechanism 6e amplifies and slows down a pressing force/speed compared with the force/speed of the pressing actuator arrangement 6f.

In general, and with reference to the example embodiment of FIG. 6a, the toggle-mechanism 6e includes link members, and the pressing actuator arrangement 6f is directly drivingly connected, or indirectly drivingly connected, to the link members, such that actuation of the pressing actuator arrangement 6f results in motion of the pressing member 6d.

The use of a toggle pressing module for forming non-flat cellulose products from an air-formed cellulose blank structure has many advantages over use of large conventional linear hydraulic presses, such as low-cost, low-weight, fast cycle operation and compactness. By having the electronic control system 6h configured for controlling operation of the pressing actuator arrangement 6f, based on pressing force indicating feedback received from the pressing force indicating arrangement 6g, the toggle pressing module becomes an advantageous replacement of conventional linear hydraulic presses.

The product forming unit U may further comprise a blank dry-forming module 4 configured for forming the cellulose blank structure 2 from the cellulose raw material R, as illustrated in FIGS. 1a-c and 2. The cellulose raw material R is provided from a suitable source and the cellulose raw material R is fed to the blank dry-forming module 4. The cellulose blank structure 2 is dry-formed from the cellulose raw material R in the blank dry-forming module 4, and thereafter the cellulose blank structure 2 is fed from the blank dry-forming module 4 to the buffering module 5. The blank dry-forming module 4 comprises a mill 4a, a forming chamber 4b, and a forming wire 4c arranged in connection to the forming chamber 4b. Fibers F from the cellulose raw material R is separated from the cellulose raw material R in the mill 4a and the separated fibers F are distributed into the forming chamber 4b onto the forming wire 4c for forming the cellulose blank structure 2. The mill 4a is configured for separating cellulose fibers F from the cellulose raw material R, and the forming chamber 4b is configured for distributing the separated fibers F onto a forming section 4d of the forming wire 4c for forming the cellulose blank structure 2. The forming section 4d is arranged in connection to a forming chamber opening 4e of the forming chamber 4b. In the illustrated embodiment, the forming section 4d is extending in an upwards blank forming direction Du. The cellulose blank structure 2 is formed onto the forming section 4d, and transported from the forming section 4d in the upwards blank forming direction Du towards the buffering module 5. The upwards blank forming direction Du is used for a compact configuration and layout of the product forming unit U, allowing an efficient positioning of the different modules of the product forming unit U in relation to each other. After forming of the cellulose blank structure 2 onto the forming section 4d, the formed cellulose blank structure 2 is transported from the forming section 4d in the upwards blank forming direction Du towards the buffering module 5.

The mill 4a is separating the fibers F from the cellulose raw material R and is distributing the separated fibers F into the forming chamber 4b. The pulp structure 20 used may for example be bales, sheets, or rolls of fluff pulp, paper structures, or other suitable cellulose fiber containing structures, that are fed into the mill 4a. The mill 4a may be of any conventional type, such as for example a hammer mill, a disc mill, a saw-tooth mill, or other type of pulp de-fiberizing machine. The pulp structure 20 is fed into the mill 4a through an inlet opening, and the separated fibers F are distributed to the forming chamber 4b through an outlet opening of the mill 4a arranged in connection to the forming chamber 4b.

The forming chamber 4b is arranged for distributing the separated fibers onto the forming wire 4c for forming the cellulose blank structure 2. The forming chamber 4b is arranged as a hood structure or compartment in connection to the forming wire 4c. The forming chamber 4b is enclosing a volume in which the separated fibers F are distributed from the mill 4a to the forming wire 4c. The fibers are distributed by a flow of air generated by the mill 4a, and the flow of air is transporting the fibers in the forming chamber 4b from the mill 4a to the forming wire 4c.

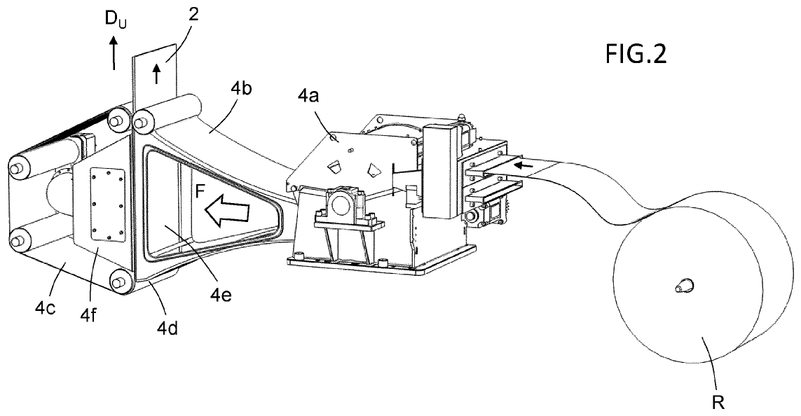

The forming wire 4c may be of any suitable conventional type, and may be formed as an endless belt structure, as understood from FIG. 2. A vacuum box 4f may be arranged in connection to the forming wire 4c and the forming chamber 4b for controlling the flow of air in the forming chamber 4b, and for distributing the separated fibers F onto the forming wire 4c.

The blank dry-forming module 4 of the embodiment illustrated in FIGS. 1a-c and 2 has a horizontal distribution direction of the fibers from the mill 4a to the forming wire 4c through the forming chamber 4b. A horizontal flow of air is thus feeding the fibers from the mill 4a to the forming section 4d, which is different from traditional dry-forming systems with a vertical flow of air. The length of the fiber carrying distance by the flow of air inside the forming chamber 4b needs to be long enough to minimize turbulence and/or create a uniform flow of cellulose fibers. Thus, the length of the blank forming module 4 is therefore dependent of the fiber carrying distance by the flow of air. The upwards blank forming direction Du is enabling the compact configuration and layout of the product forming unit U, and is reducing the length of the product forming unit U compared to traditional solutions. Further, access for maintenance of the mill 4a from a plant floor level is enabled without additional elevated flooring structures or platforms, due to the positioning of the blank dry-forming unit 4 at the plant floor level. This positioning and the horizontal flow of air also enables low height of the product forming unit U compared to traditional solutions using vertical air flow.

Other suitable types of blank dry-forming modules may also be used, such as for example web forming wheels.

The product forming unit U may further comprise a barrier application module 8 arranged upstream the buffering module 5, as shown in FIGS. 1a-b. The barrier application module 8 is configured for applying a barrier composition onto the cellulose blank structure 2 before forming the cellulose products 1 in the one or more forming molds 3.

One preferred property of the cellulose products 1 is the ability to hold or withstand liquids, such as for example when the cellulose products are used in contact with beverages, food, and other water-containing substances. The barrier composition may be one or more additives used when producing the cellulose products, such as for example AKD or latex, or other suitable barrier compositions. Another suitable barrier composition is a combination of AKD and latex, where tests have shown that unique product properties may be achieved with a combination of AKD and latex added to the air-formed cellulose blank structure 2 when forming the cellulose products 1. When using the combination of AKD and latex, a high level of hydrophobicity can be achieved, resulting in cellulose products 1 with a high ability to withstand liquids, such as water, without negatively affecting the mechanical properties of the cellulose products 1.

The barrier application module 8 may be arranged as a hood structure in connection to the cellulose blank structure 2, and the hood structure is comprising spray nozzles that are spraying the barrier composition continuously or intermittently onto the cellulose blank structure 2. In this way, the barrier composition is applied onto the cellulose blank structure 2 in the barrier application module 8. The barrier composition may be applied on only one side of the cellulose blank structure or alternatively on both sides. The barrier composition may further be applied over the whole surface or surfaces of the cellulose blank structure 2, or only on parts or zones of the surface or surfaces of the cellulose blank structure 2. The hood structure of the barrier application module is preventing the barrier composition from being spread into the surrounding environment. Other application technologies for applying the barrier structure may for example include slot coating and/or screen-printing.

The feeding route and feeding direction of the cellulose blank structure 2 of the example embodiment of FIGS. 1a-c is for clarification purposes schematically illustrated in FIG. 1d, and the compact configuration and layout of the product forming unit U enabled by routing the cellulose blank structure 2 first primarily upwards, then primarily horizontal and subsequently primarily downwards is clearly understandable, when compared with a conventional straight line horizontal routing of a cellulose product compression forming process.

Alternatively, the blank dry-forming module 4 may be arranged to have a primarily horizontal orientation of the feeding route and feeding direction of the cellulose blank structure 2, with a primarily horizontal orientation of the forming wire 4c in the area of the forming chamber opening 4e, as schematically illustrated in FIG. 1e, before routing the cellulose blank structure 2 upwards, then primarily horizontal and subsequently primarily downwards to the pressing module 6. This layout of the product forming unit U may also be used for providing a compact product forming unit U.

With reference to FIGS. 1d-e, the blank dry-forming module 4 typically forms the start of the feeding route and the pressing module 6 typically forms the end of the feeding route, when not taking a blank recycling module 7 into account. Other modules, such as the buffering module 5 and barrier application module 8 are located at suitable positions between the dry-forming module 4 and the pressing module 6, downstream the dry-forming module 4 and upstream the pressing module 6, and not necessarily at the example positions of the embodiment of FIGS. 1a-c.

The primarily downwards routing of the cellulose blank structure while passing the pressing module 6 is beneficial in terms of simplified feeding of the cellulose blank structure 2, as well as simplified cellulose products 1 removal after completed forming process upon leaving the pressing module 6.

Specifically, high-speed intermittent feeding of the cellulose blank structure 2 from the buffering module 5 to the pressing module 6 may be difficult to accomplish without damaging or altering the characteristics of the cellulose blank structure 2, such as the thickness of the cellulose blank structure 2, or the like. However, by arranging the toggle press in a primarily horizontal direction D_{H} and feeding the cellulose blank structure primarily downwards to the pressing module 6, the gravitational force assists this feeding process, thereby requiring less force to be applied by a feeding device for feeding the continuous cellulose blank structure 2 into the pressing area A_{P} of the pressing module 6, and thereby reducing the risk for damages and/or altered characteristics of the cellulose blank structure 2.

Moreover, removal of the finished and ejected cellulose products 1 after completed forming process may also be simplified by means of the primarily vertical routing of the cellulose blank structure 2 through the forming mold 3, because the gravitational force may also here assist and simply removal of the finished and ejected cellulose products 1 from the forming mold 3, and subsequent transportation to a storage chamber or conveyer belt, or the like.

Further, in the embodiment illustrated in FIGS. 1a-c, the product forming unit U comprises a blank recycling module 7 for recycling cellulose fibers. The blank recycling module 7 is configured for feeding residual parts 2a of the cellulose blank structure 2 after forming of the cellulose products 1, from the pressing module 6 back to the blank dry-forming module 4. The blank recycling module 7 is arranged for transporting residual cellulose blank fiber material from the pressing module 6 to the mill 4a. After forming of the cellulose products 1 in the forming molds 3, there may be residual parts 2a of the cellulose blank structure containing cellulose blank fiber material. With the blank recycling module 7, the residual or remaining cellulose fibers can be recycled and re-used for forming a new cellulose blank structure 2 together with fibers from the cellulose raw material. In FIGS. 1a-c, an example embodiment of a blank recycling module 7 is schematically illustrated. The blank recycling module 7 comprises a feeding structure 7a, such as feeding belts, a conveyer structure, or other suitable means for transporting the residual parts 2a from the forming molds 3 to the mill 4a. The mill 4a may be arranged with a separate inlet opening for the residual material, where the residual parts 2a of the cellulose blank structure 2 are fed into the mill 4a.

In a non-illustrated embodiment, the blank recycling module 7 may instead comprise a channel structure with an inlet portion 28 arranged in connection to the forming molds 3, and the residual parts 2a of the cellulose blank structure can be sucked into the inlet portion for further transportation to the mill 4a. The channel structure may further be arranged with a suitable combined mill and fan unit, which is used for at least partly separate the residual material before further transportation to an outlet portion in connection to the mill 4a.

The product forming unit U may further comprise transportation or feeding devices for continuously or intermittently feeding the cellulose blank structure between the different modules. The transportation devices may be arranged as conveyor belts, vacuum belts, or similar devices for an efficient transportation. According to some example embodiments, the feeding devices may include elongated vacuum belt feeders, elongated tractor belt feeders or the like.

With the product forming unit U comprising the buffering module 5, where the cellulose blank structure 2 is continuously fed to the buffering module 5 in a first feeding direction D_{F1}, and intermittently fed from the buffering module 5 in a second feeding direction D_{F2}, where the first feeding direction D_{F1} and the second feeding direction D_{F2} differ, a compact construction of the product forming unit U is enabled. The differing feeding directions enable the modules to be integrated into one single product forming unit U that is possible to ship in a freight container, and placed on a converter's plant floor in a simple manner. The differing feeding directions enable a more compact layout and construction of the product forming unit, where the modules efficiently can be arranged both horizontally and vertically in relation to each other as understood from the figures.

The present disclosure has been presented above with reference to specific embodiments. However, other embodiments than the above described are possible and within the scope of the disclosure. Different method steps than those described above, performing the method by hardware or software, may be provided within the scope of the disclosure. Thus, according to an exemplary embodiment, there is provided a non-transitory computer-readable storage medium storing one or more programs configured to be executed by one or more processors of the control system, the one or more programs comprising instructions for performing the method according to any one of the above-discussed embodiments. Alternatively, according to another exemplary embodiment a cloud computing system can be configured to perform any of the method aspects presented herein. The cloud computing system may comprise distributed cloud computing resources that jointly perform the method aspects presented herein under control of one or more computer program products. Moreover, the processor may be connected to one or more communication interfaces and/or sensor interfaces for receiving and/transmitting data with external entities such as e.g. sensors, an off-site server, or a cloud-based server.

The processor or processors associated with the control system may be or include any number of hardware components for conducting data or signal processing or for executing computer code stored in memory. The system may have an associated memory, and the memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims. Reference signs mentioned in the claims should not be seen as limiting the extent of the matter protected by the claims, and their sole function is to make claims easier to understand.

1. A method for manufacturing non-flat cellulose products from an air-formed cellulose blank structure in a product forming unit, wherein the product forming unit comprises a buffering module and a pressing module comprising one or more forming molds, wherein the method comprises the steps of:
providing the cellulose blank structure and feeding the cellulose blank structure to the buffering module;
buffering the cellulose blank structure in the buffering module, and feeding the cellulose blank structure from the buffering module to the pressing module; and
forming cellulose products from the cellulose blank structure in the one or more forming molds by heating the cellulose blank structure to a forming temperature, and pressing the cellulose blank structure (2) with a forming pressure (P_{F});
wherein the cellulose blank structure is continuously fed to the buffering module in a first feeding direction, and intermittently fed from the buffering module in a second feeding direction, wherein the second feeding direction differs from the first feeding direction.

2. The method according to claim 1,
wherein the first feeding direction is opposite to, or essentially opposite to, the second feeding direction.

3. The method according to claim 1,
wherein the first feeding direction (D_{F1}) is an upwards direction and the second feeding direction (D_{F2}) is a downwards direction.

4. The method according to claim 1,
wherein the cellulose blank structure is intermittently fed from the buffering module to the pressing module.

5. The method according to claim 1,
wherein the buffering module is configured for alternatingly operating in a buffering mode and a feeding mode,
wherein the method further comprises the steps of: feeding the cellulose blank structure to the buffering module in the buffering mode and the feeding mode with a continuous input speed; and feeding the cellulose blank structure from the buffering module in the buffering mode with an output speed lower than the output speed of the cellulose blank structure from the buffering module in the feeding mode.

6. The method according to claim 5,
wherein the output speed in the buffering mode is zero, or wherein the output speed in the buffering mode is essentially zero.

7. The method according to claim 5,
wherein the buffering module comprises an inlet portion, an outlet portion, and a buffering portion between the inlet portion and the outlet portion, wherein the cellulose blank structure has a buffering extension in the buffering portion between the inlet portion and the outlet portion, wherein the method further comprises the steps of: gradually increasing the buffering extension of the cellulose blank structure in the buffering portion during the buffering mode, and gradually decreasing the buffering extension of the cellulose blank structure in the buffering portion during the feeding mode.

8. The method according to claim 7,
wherein the buffering portion comprises a guide member, wherein the guide member comprises a first arm section and a second arm section configured for intermittently varying the buffering extension in the buffering mode and the feeding mode, wherein the method further comprises the steps of: varying an angular relationship between the first arm section and the second arm section in the buffering mode and the feeding mode for varying the buffering extension.

9. The method according to claim 8,
wherein the method further comprises the steps of: continuously feeding the cellulose blank structure to the inlet portion and intermittently feeding the cellulose blank structure from the outlet portion through activation of the guide member, wherein during activation of the guide member in the buffering mode a buffer of the cellulose blank structure is built in the buffering portion, and wherein during activation of the guide member in the feeding mode a buffer of the cellulose blank structure is released from the buffering portion.

10. The method according to claim 1,
wherein the product forming unit comprises a blank dry-forming module configured for providing the cellulose blank structure,
wherein the method further comprises the steps of:
providing a cellulose raw material and feeding the cellulose raw material to the blank dry-forming module; dry-forming the cellulose blank structure from the cellulose raw material in the blank dry-forming module; and feeding the cellulose blank structure from the blank dry-forming module to the buffering module.

11. The method according to claim 10,
wherein the blank dry-forming module comprises a mill, a forming chamber, and a forming wire arranged in connection to the forming chamber, wherein the method further comprises the steps of: separating fibers from the cellulose raw material in the mill and distributing the separated fibres for forming the chamber onto the forming wire for forming the cellulose blank structure.

12. The method according to claim 11,
wherein the forming wire comprises a forming section arranged in connection to a forming chamber opening of the forming chamber, wherein the method further comprises the step of: forming the cellulose blank structure onto the forming section.

13. The method according to claim 12,
wherein the forming section is extending in an upwards blank forming direction, wherein the method further comprises the steps of: forming the cellulose blank structure onto the forming section, and transporting the formed cellulose blank structure from the forming section in the upwards blank forming direction towards the buffering module.

14. The method according to claim 10,
wherein the product forming unit comprises a blank recycling module, and wherein the method further comprises the steps of: feeding residual parts of the cellulose blank structure from the pressing module to the blank dry-forming module.

15. The method according to claim 1,
wherein the product forming unit comprises a barrier application module arranged upstream the buffering module, and wherein the method further comprises the step of: applying a barrier composition onto the cellulose blank structure in the barrier application module.

16. The method according to claim 1,
wherein the method further comprises the steps of: forming the cellulose products from the cellulose blank structure in the one or more forming molds by heating the cellulose blank structure to a forming temperature in the range of 100-300° C., and pressing the cellulose blank structure with a forming pressure in the range of 1-100 MPa.

17. The method according to claim 1,
wherein the pressing module is a cellulose product toggle pressing module for forming the non-flat cellulose products from the cellulose blank structure, wherein the method further comprises the steps of:
providing the cellulose product toggle pressing module having a toggle press and the one or more forming molds, wherein the toggle press includes a pressing member movably arranged in a pressing direction, a toggle-mechanism connected to the pressing member, a pressing actuator arrangement connected to the toggle-mechanism, and an electronic control system operatively connected to the pressing actuator arrangement, and wherein the one or more forming molds each includes a moveable first mold part attached to the pressing member and a stationary second mold part,
installing the toggle press with the pressing direction of the pressing member arranged primarily in a horizontal direction, specifically with the pressing direction of the pressing member arranged within 20 degrees from the horizontal direction, and more specifically with the pressing direction in parallel with the horizontal direction,
feeding the cellulose blank structure into a pressing area defined by the first and second, spaced apart, mold parts,
controlling operation of the pressing actuator arrangement by means of the electronic control system for driving the pressing member using the toggle-mechanism in the pressing direction and forming the cellulose products from the cellulose blank structure by pressing each first forming mold part against the stationary second forming mold part.

18. A product forming unit for manufacturing non-flat cellulose products from an air-formed cellulose blank structure, the product forming unit comprising:
a buffering module, and
a pressing module comprising one or more forming molds,
wherein the product forming unit is adapted for feeding the cellulose blank structure to the buffering module, buffering the cellulose blank structure in the buffering module, and feeding the cellulose blank structure from the buffering module to the pressing module,
wherein the product forming unit further is adapted for forming the cellulose products from the cellulose blank structure in the one or more forming molds by heating the cellulose blank structure to a forming temperature, and pressing the cellulose blank structure with a forming pressure;
wherein the buffering module comprises a blank feeding system configured for continuously feeding the cellulose blank structure to the buffering module in a first feeding direction, and intermittently feeding the cellulose blank structure from the buffering module in a second feeding direction, wherein the second feeding direction differs from the first feeding direction.

19. The product forming unit according to claim 18,
wherein the buffering module comprises an inlet portion, an outlet portion, and a buffering portion between the inlet portion and the outlet portion, wherein the cellulose blank structure is arranged with a buffering extension in the buffering portion between the inlet portion and the outlet portion, wherein the buffering portion is configured for gradually increasing the buffering extension of the cellulose blank structure during a buffering mode, and gradually decreasing the buffering extension of the cellulose blank structure during a feeding mode.

20. The product forming unit according to claim 19,
wherein the buffering portion comprises a guide member, wherein the guide member comprises a first arm section and a second arm section configured for intermittently varying the buffering extension in the buffering mode and the feeding mode, wherein the buffering portion is configured for varying an angular relationship between the first arm section and the second arm section in the buffering mode and the feeding mode for varying the buffering extension.

21. The product forming unit according to claim 19,
wherein the blank feeding system comprises at least one blank feeding roller arranged in connection to or upstream the inlet portion, and/or in connection to or downstream the outlet portion.

22. The product forming unit according to claim 19,
wherein the buffering module comprises a first blank redirecting device arranged upstream the inlet portion and/or a second blank redirecting device arranged downstream the outlet portion.

23. The product forming unit according to claim 19,
wherein the blank feeding system is configured for continuously feeding the cellulose blank structure to the inlet portion and intermittently feeding the cellulose blank structure from the outlet portion through activation of the guide member, wherein during activation of the guide member in the buffering mode a buffer of the cellulose blank structure is built in the buffering portion, and wherein during activation of the guide member in the feeding mode the buffer of the cellulose blank structure is released from the buffering portion.

24. The product forming unit according to claim 18,
wherein the product forming unit comprises a blank dry-forming module configured for providing the cellulose blank structure.

25. The product forming unit according to claim 24,
wherein the blank dry-forming module comprises a mill, a forming chamber, and a forming wire arranged in connection to the forming chamber, wherein the mill is configured for separating fibers from a cellulose raw material, wherein the forming chamber is configured for distributing the separated fibers onto a forming section of the forming wire for forming the cellulose blank structure.

26. The product forming unit according to claim 25,
wherein the forming section is extending in an upwards blank forming direction.

27. The product forming unit according to claim 24,
wherein the product forming unit comprises a blank recycling module configured for feeding residual parts of the cellulose blank structure from the pressing module to the blank dry-forming module.

28. The product forming unit according to claim 18,
wherein the product forming unit comprises a barrier application module arranged upstream the buffering module, wherein the barrier application module is configured for applying a barrier composition onto the cellulose blank structure.

29. The product forming unit according to claim 18,
wherein the one or more forming molds are configured for forming the cellulose products from the cellulose blank structure by heating the cellulose blank structure to a forming temperature in the range of 100-300° C., and pressing the cellulose blank structure with a forming pressure in the range of 1-100 MPa.

30. The product forming unit according to claim 18,
wherein the pressing module is a cellulose product toggle pressing module for forming the non-flat cellulose products from the cellulose blank structure, wherein the pressing module comprises: a toggle press including a pressing member movably arranged in a pressing direction, a toggle-mechanism drivingly connected to the pressing member, a pressing actuator arrangement drivingly connected to the toggle-mechanism, and an electronic control system operatively connected to the pressing actuator arrangement, and the one or more forming molds each including a moveable first mold part attached to the pressing member and a stationary second mold part, wherein the electronic control system is configured for controlling operation of the pressing actuator arrangement for driving the pressing member using the toggle-mechanism in the pressing direction and forming the non-flat cellulose product from the air-formed cellulose blank structure by pressing the first mold part against the stationary second mold part, and wherein the toggle press is installed with, or arranged for being installed with, the pressing direction of the pressing member arranged primarily in a horizontal direction, specifically with the pressing direction of the pressing member arranged within 20 degrees from the horizontal direction, and more specifically with the pressing direction in parallel with the horizontal direction.
